(19) United States
(12) Patent Application Publication
(10) Pub. No.: US 2012/0271697 A1
(43) Pub. Date: Oct. 25, 2012

(54) METHODS AND SYSTEMS FOR OFFER AND DYNAMIC GIFT VERIFICATION AND REDEMPTION

(75) Inventors: Andrea Christine GILMAN, Chappaqua, NY (US); Diane Shaib Kretschmann, Greenswich, CT (US); Jose-Luis Celorio Martinez, New York, NY (US); Scott Moser, Kings Park, NY (US)

(73) Assignee: MASTERCARD INTERNATIONAL, INC., Purchase, NY (US)

(21) Appl. No.: 13/455,951

(22) Filed: Apr. 25, 2012

Related U.S. Application Data
(60) Provisional application No. 61/478,763, filed on Apr. 25, 2011.
(60) Provisional application No. 61/486,172, filed on May 13, 2011.
(60) Provisional application No. 61/507,964, filed on Jul. 14, 2011.

(51) Int. Cl. G06Q 20/40; G06Q 30/06; G06Q 30/02

(52) U.S. Cl. 705/14.23; 705/26.35; 705/44

(57) ABSTRACT

Methods and systems are disclosed for using a financial transaction card number system of a payment processing network as part of offer and gift distribution, verification and redemption systems. In an embodiment, a method receives indication of acceptance of an offer from a consumer and initiates processing of consumer payment using a financial transaction card number associated with the consumer. The method sends an intelligent transaction card (ITC) number to be used with a redemption code to purchase products or services contained in the offer. In another embodiment, a system generates and redeems a dynamic gift by requesting a gift code based on controls for the gift. Upon receiving indication that the gift has been redeemed, the system receives the gift code and authorization from a merchant and checks validity of the gift based on the controls. The system approves the gift redemption if the redemption is within the controls.

### CROSS-REFERENCE TO RELATED APPLICATIONS

The present application claims the benefit of U.S. Provisional Appl. No. 61/478,763 filed Apr. 25, 2011, U.S. Provisional Appl. No. 61/486,172 filed May 23, 2011 and U.S. Provisional Appl. No. 61/507,964 filed Jul. 14, 2011. These prior applications, which are each entitled “Offer Verification and Redemption Method and System”, are incorporated by reference herein in their entireties.

### FIELD OF THE DISCLOSURE

The present disclosure is directed to a method and apparatus (collectively a system) of verifying offers and redeeming them using in part a financial transaction card processing system or network as a part thereof.

### DESCRIPTION OF RELATED ART

At the time of the filing of this application, with the increased popularity of smartphones and social networking sites, new avenues of commerce have become a major market force. Use of these new media to convey offers for special deals and discounts has become more successful than expected. One such program involves “a system and methods for offering goods and services of others at a discount on a network such as the Internet, wherein the sale of the goods and services is contingent upon a certain number of actual sales, i.e., a tipping point, where the merchant ultimately providing the goods or services does not pay the out-of-pocket expenses for advertising and marketing the goods or services, and receives the revenue generated from the sales of the discounted goods or services before actually providing those goods or services. Once the customer accepts an offer, payment information for that offer is exchanged, but no payment is actually made. If and when the required number of offers are accepted, i.e., the tipping point, payment based on the payment information is completed.” U.S. Published Patent Application No. 2010/0287103, incorporated herein by reference in its entirety. This patent publication is owned by Groupon. Similar services are offered by Google Offers, Amazon, BuyWithMe, LivingSocial, HTC Corporation, and Dealon, to name a few offer distributors at the time of the filing of this application.

Currently, the offer distributors listed above and other players have competing business models, processes, and approaches resulting from competing for shares in the offers and ‘daily deals’ marketplace. This has resulted in inefficient and fragmented systems with multiple touch points for consumers and merchants. The competition amongst and lack of coordination and cooperation between these players has also resulted in offer overload for consumers with imperfect information and redundant processes for consumers to follow in order to avail themselves of offers. Many of the existing processes and approaches also involve proprietary systems for offer redemption and payment. This is due in part to multiple standards for offer and gift categorization, redemption and measurement.

Accordingly, what is needed are technical solutions that provide access to a worldwide processing network that works with issuers and telecommunications companies (telcos). What is also needed are systems that provide abilities to set transaction controls, filter transactions, make plastic track offers, and provide access to a transaction data warehouse for reporting and analytics services. What is further needed are methods that provide fast and flexible services using common standards while also enabling consumer control of information regarding data and offers received. These systems also need to provide tracking and reporting of offers and redemptions to ensure return on investment (ROI) for merchants and offer distributors while simultaneously providing improved consumer and merchant experiences.

Credit card companies such as a payment processor provide various services and product offerings to support its customer and vendor bases. One such product offering, MasterCard's inControl™ authorization system, allows cardholders to set custom controls on usage of their credit, debit and prepaid cards, and even block transactions that they deem inappropriate. Additionally, it enables them to receive real-time alerts about card activity via email or text message. As a result, they can manage their finances more efficiently and spend with greater confidence. This is accomplished by using virtual card numbers (VCNs) that are formatted and are processed the same as regular credit and debit card numbers by merchants and acquirers, but at the issuer or at the card processor (e.g., MasterCard), the VCN is mapped in a database to the regular card number for normal authorization checks, and also to controls that are in addition to the normal authorization checks that can be set by the card holder, such as spend limits (both maximum amount per transaction and over a time period), limits on types of merchants or a single merchant, geographic location based controls, etc. See, U.S. Pat. No. 6,315,193; U.S. Pat. No. 6,793,131; U.S. application Ser. No. 10/914,766, filed on Aug. 9, 2004; U.S. application Ser. No. 11/560,212, filed on Nov. 15, 2006; U.S. application Ser. No. 12/219,952, filed on Jul. 30, 2008; and International Application No. PCT/US2009/005029, filed on Sep. 19, 2009, all incorporated herein by reference in their entirety (herein the controlled payment numbers or CPN Patents). One iteration of a VCN is a P-Card™ or Purchase card, which can have limits set by a supervising entity and used by another (e.g., a boss sets limits on the P-card given to an employee). Payment processors and other financial transaction card processors, networks and issuers also offer prepaid card processing.

### SUMMARY

Methods, systems, and apparatus are disclosed for using a financial transaction card (e.g., credit, debit, pre-paid card, virtual, hybrid or nearly any other types of payment cards used for transacting business) number system as an integral part of an offer distribution, verification and redemption system. It can also involve reporting and settlement, as well. An embodiment provides single use coupon numbers that allow consumers to print vouchers as they do today, but are validated using existing payment network capabilities.

An embodiment enables use of physical plastic redemption cards which can be issued to consumers who can redeem their vouchers by swiping their redemption cards without needing to print out a paper coupon.

In another embodiment, a method for pre-purchased deal voucher validation and analytics is provided so that controls can be imposed on vouchers and deal analytics can be captured. The method improves the redemption experience.

In yet another embodiment, a technical solution for dynamic gifting provides the ability to dynamically generate “gifts” and to constrain these gifts to specific merchant locations, merchant categories, and usage timing (i.e., time of day, day of week, and expiration date). The technical solution captures the dynamic gift usage analytics and consumer habits.

In an embodiment, a system provides an electronic solution for points of sale coupon processing that provides real time authentication of the coupon to mitigate potential coupon miss-use at retail locations worldwide, and one that creates a seamless process for the consumer.

This exemplary system also fulfills tracking and reporting needs, and enables making deals, offers and gifts “go live” to consumers in real time. Additionally, the system provides a solution that allows offer distributors to settle with their merchant partners utilizing a commercial purchase control platform, which funding administrator utilizes today, that is it is adaptable to the legacy financial transaction account system.

According to another embodiment, a technical solution leverages the inControl™ authorization system for both Virtual Card Numbers/VCNs and retail purse functionality to provide different funding mechanisms (i.e., different purses) and partial authorization. This exemplary solution handles validation of a voucher, and any overage spent at a Point of Sale (POS). Exemplary steps for performing this technical solution are outlined in the following paragraphs. Exemplary systems and methods for managing and processing overages for daily deals are described in U.S. Provisional Appl. No. 61/586,049, entitled “Systems and Methods for Managing Overages in Daily Deals,” filed Jan. 12, 2012, which is incorporated by reference herein in its entirety.

In an initial step, a consumer (i.e., cardholder or user) initiates a transaction with a pre-paid voucher for a total amount of the value of the services received irrespectively of the value of a coupon. Next, the voucher is presented. According to embodiments, such voucher presentation can be in paper form or using a mobile computing device, such as, but not limited to, a smartphone.

At this point, the transaction can be initiated either by key entering the code into the POS or by scanning a QR or bar code, so as to effectively capture a 16 digit code which would be an inControl™ generated ICN.

Next, the transaction can be routed to an issuer (see issuer 550 of FIG. 5), which in one embodiment can be a pre-paid issuer and payment processor that can handle purse functionality (e.g., Meta Bank and Access) with a purse functionality.

After the transaction is routed to an issuer, the voucher amount is associated with the ICN that initiated the transaction. When the issuer receives the request for authorization, it will then discount the value of the voucher from the total and return a partial authorization.

In one exemplary embodiment, when there is no overage, the partial authorization sent back would be 0 (zero). In an alternative embodiment, if there is no overage, the partial authorization is returned for a nominal amount (e.g., $1) in order to complete the transaction. With either of these embodiments, after the partial authorization is returned, the transaction would be complete.

If there is an overage, the purse functionality would kick in. In accordance with an exemplary embodiment, first a partial authorization for the overage can be sent back to a merchant and that overage amount would hit a second purse. This second purse can be associated with an alternative funding source (e.g., the consumer's payment account/card account or a pre-paid account). In accordance with an exemplary embodiment, this association can be done through the Retail functionality of inControl™.

Finally, in an embodiment of this technical solution, only the partial authorization would clear and settle, so in cases where there is no overage, nothing would clear, and if there is an overage, this overage would clear and hit the consumer's account for funding.

These and other features and advantages of the present disclosure will become apparent from the following detailed description of illustrative embodiments thereof, which is to be read in connection with the accompanying drawings.

### BRIEF DESCRIPTION OF THE DRAWING FIGURES

FIG. 1 is high-level computer architecture of an exemplary financial processing system for carrying out an embodiment of the presently disclosed system.

FIG. 2 is a data flow diagram overlaid on the computer architecture diagram of FIG. 1.

FIGS. 3A and 3B are data flow diagrams depicting steps for deal purchasing and redemption processes, according to embodiments of the present disclosure.

FIG. 4 is a data flow diagram for virtual card number (VCN) mapping, according to an embodiment of the present disclosure.

FIG. 5 is a block diagram illustrating bi-directional communication of the financial processing system of FIGS. 1 and 2 for processing deal purchasing and redemption, according to an embodiment of the present disclosure.

FIG. 6 illustrates how a payment processor can act as a distribution hub for developers to present and create offers applications for consumers so that offer providers can target offers for syndication, according to an embodiment of the present disclosure.

FIG. 7 illustrates features of an offers application programming interface (API), according to an embodiment of the present disclosure.

FIG. 8 depicts offer validation and tracking features of a marketing control system for the deal purchasing and redemption processes of FIGS. 3A and 3B, according to an exemplary embodiment of the present disclosure.

FIG. 9 illustrates features of a card linked offer redemption solution, according to an exemplary embodiment of the present disclosure.

FIG. 10 is a data flow diagram depicting steps for processing limited-use, dynamic virtual gift cards according to an exemplary embodiment of the present disclosure.

FIG. 11 is a flowchart depicting steps by which dynamic gift cards are generated, managed, redeemed, and funded, according to an exemplary embodiment of the present disclosure.

FIG. 12 illustrates roles and responsibilities of entities involved in dynamic gift processing, according to an exemplary embodiment of the present disclosure.

FIG. 13 is a diagram of an exemplary computer system in which embodiments of the present disclosure can be implemented.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

As used herein, “credit card number” is sometimes used interchangeably with financial transaction card number and means a credit card, debit card, pre-paid card, hybrid card, plastic or virtual card number (VCN), or nearly any other account number that facilitates a financial transaction using a transaction clearance system. VCNs and pre-paid card numbers and other financial transaction card number that can be generally viewed as being more readily issued and disposed of because they do not require the establishment of a line of credit, and can be linked to various controls (amounts, cumulative amounts, duration, controls on spending by amounts, cumulative amounts, types of merchants, geographic controls, to name a few). As used herein, these types of cards (VCN, pre-paid, etc.) are referred to as intelligent transaction card (ITC) numbers.

As used herein, “payment account”, “credit card number” and “credit card” are sometimes used interchangeably. These terms mean a credit card, debit card, pre-paid card, hybrid card, plastic or virtual card number (VCN) (single use, limited use or simply virtual), or nearly any other account number that facilitates a financial transaction using a transaction clearance system. VCNs and pre-paid card numbers and other financial transaction card number that can be generally viewed as being more readily issued and disposed of because they do not require the establishment of a line of credit, and optionally can be linked to various controls (amounts, cumulative amounts, duration, controls on spending by amounts, cumulative amounts, types of merchants, geographic controls, to name a few).

As used herein, an “offer” is sometimes used interchangeably with a deal and means an exchange of an incentive for a consumer action. For example, an offer can be for a percentage or monetary discount (i.e., dollars off), or it can be for a product, such as a free appetizer with a meal from a dining establishment/restaurant merchant. As used herein, redemption of an offer refers to an action of a consumer to present the deal and exchange it for goods and/or services at a merchant. An “overage” is an amount spent by a consumer at a merchant above and beyond the amount of an offer or voucher being redeemed by the consumer at the merchant.

Further, as used herein, the terms “user”, “customer”, “consumer”, and “cardholder” can be used interchangeably and can include any user making purchases of goods and/or services (e.g., by availing themselves of offers or redeeming gifts). Unless specifically stated differently or from context, in exemplary embodiments, a user may be interchangeably used herein to identify a human consumer, a software application, or a group of customers and/or software applications executed by one or more consumers to conduct offer purchases or gift redemption transactions. Besides a human customer who can purchase items and redeem offers and gifts, a software application can be used to process purchases and to redeem offers and gifts. Accordingly, unless specifically stated, the terms “user”, “customer”, “cardholder”, and “consumer” as used herein do not necessarily pertain to a human being.

Further, as used herein, the term “issuer” can include, for example, a financial institution (e.g., bank) issuing a card, a merchant issuing a merchant specific card, a stand-in processor configured to act on-behalf of the card-issuer, or any other suitable institution configured to issue a financial card. Finally, as used herein, the term “transaction acquirer” can include, for example, a merchant, a merchant terminal, a point-of-sale (POS) terminal at a merchant, or any other suitable institution or device configured to initiate a financial transaction per the request of a customer.

### I. SYSTEM ARCHITECTURE

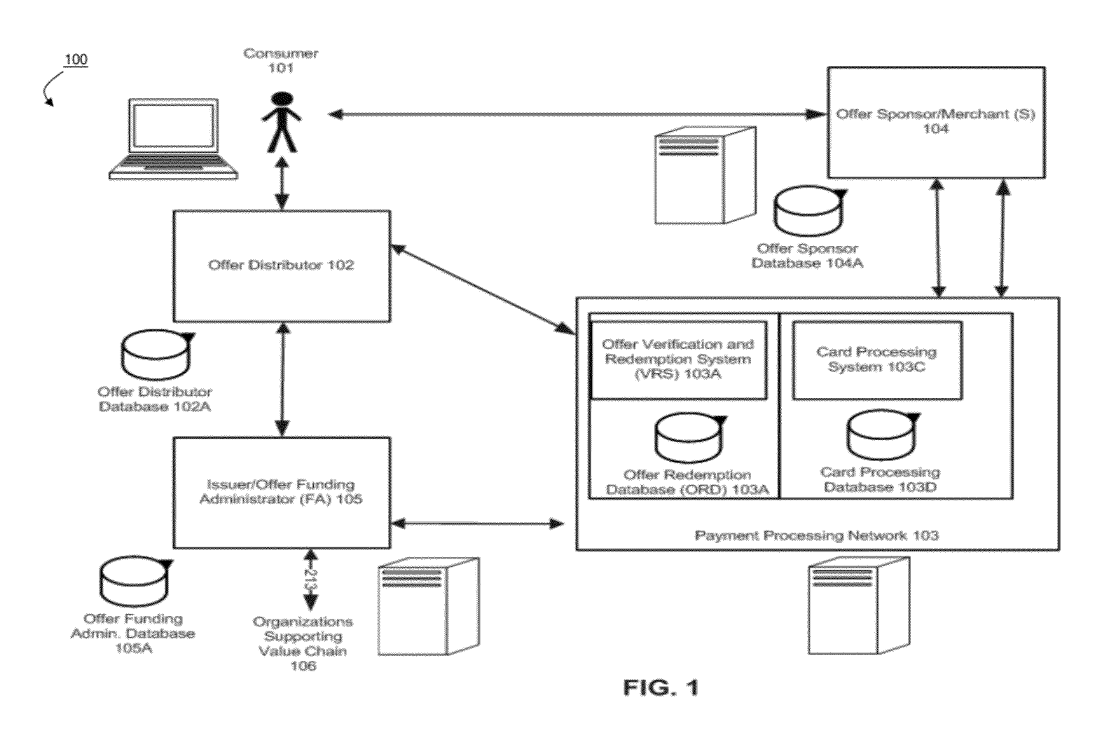

FIG. 1 depicts an exemplary high level computer architecture 100 of an exemplary system for carrying out an embodiment of the presently disclosed invention. As depicted in FIG. 1 and implemented in the presently described exemplary embodiment, the computer architecture 100 includes a consumer 101, an offer distributor 102, payment processing system 103 (e.g., MasterCard's inControl™ authorization system, pre-paid card authorization system or other ITC number processing system or network), an offer sponsor/merchant 104 and a funding administrator 105 (e.g., a bank or other financial institution). Communication between the various components can be through public and/or private networks or virtual private networks (e.g., the Internet particularly with respect to communications with the consumer, and private networks for others).

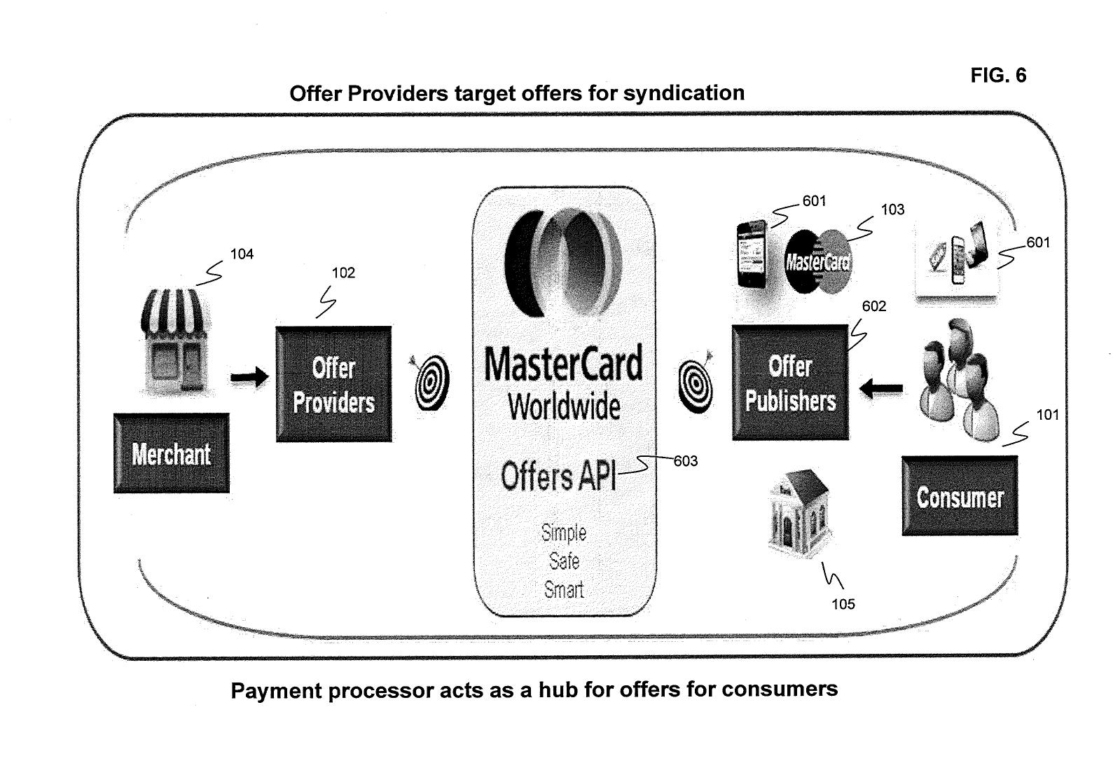

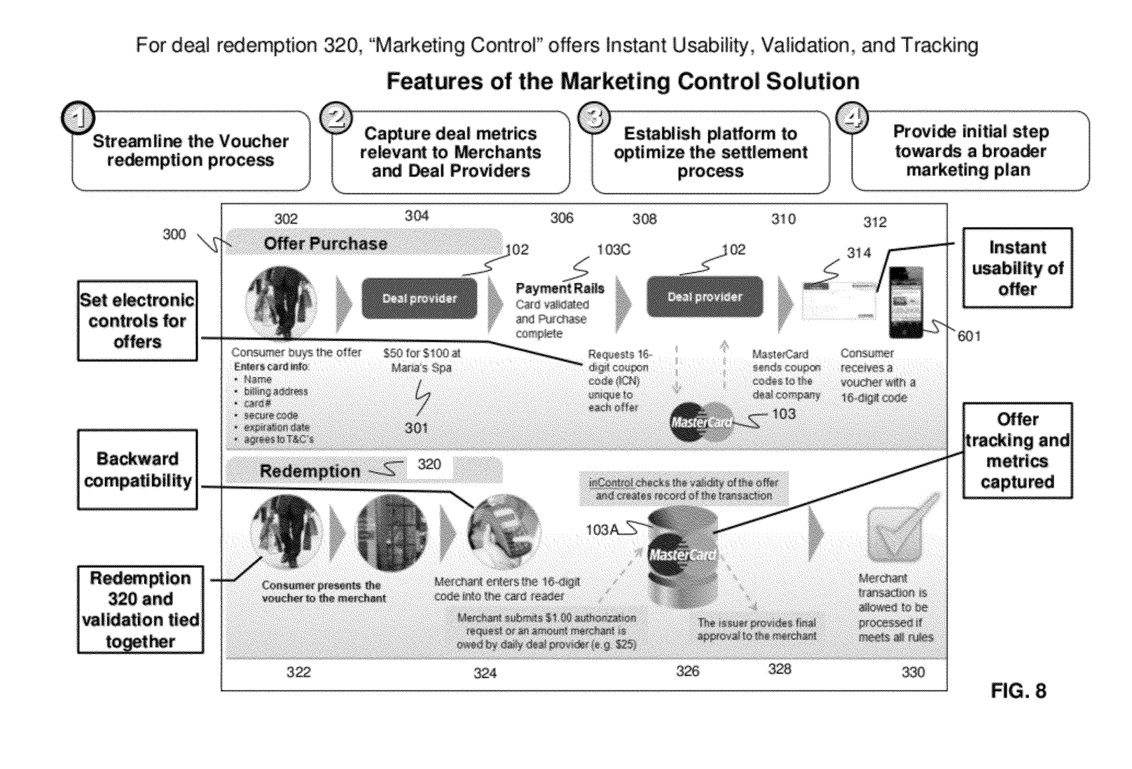

The consumer 101 can be a natural person, but generally as used herein is a consumer's computer connected via a browser to the Internet. The consumer 101, using a user interface (UI) and Input/Output (I/O) devices (such as a touchscreen, pointing device, keyboard, mouse or other suitable I/O devices) can receive offers and transact business, including making payment as part of accepting an offer using a financial transaction card (credit, debit, pre-paid, virtual, hybrid or nearly any other types of cards used for transacting business). This is shown by the two-way arrows inter-connecting the consumer 101 to an offer distributor 102 (e.g., a website) and to a merchant 104. The architecture 100 allows a consumer 101 to use any mobile computing device, such as the mobile devices 601 depicted in FIGS. 6 and 8, to accept offers from offer distributor 102, including, but not limited to, a Personal Digital Assistant (PDA), a tablet computing device, an iPhone™, an iPod™, an iPad™, a device operating the Android operating system (OS) from Google Inc., a device running the Microsoft Windows® Mobile OS, a device running the Microsoft Windows® Phone OS, a device running the Symbian OS, a device running the webOS from Hewlett Packard, Inc., a mobile phone, a BlackBerry® device, a smartphone, a hand held computer, a netbook computer, a palmtop computer, a laptop computer, an ultra-mobile PC, a portable gaming system, or another similar type of mobile computing device having a capability to accept offers from offer distributor 102.

The offer distributor 102 may be a single entity or multiple parties (e.g., deal originators such as Groupon and the like), deal aggregators, and deal publishers, whether working independently or collectively, but each entity that has computers, databases 102A and servers and/or routers to distribute offers for goods or services, often at a discounted price or other special deal. The distributor 102 can be a website or service (e.g., Groupon), advertising agency, or part of a merchant, payment processing network or card issuer to name a few possibilities. The offer distributor 102 may only distribute offers on behalf of another, but may compose, target, track and report usage of various offers to the merchant providing the product or service or others. It has a user interface and at least the conventional I/O devices. Though only one is shown, each offer distributor may have many I/O devices and computers computer systems, servers, routers and network(s), and there may be many of the offer distributors 102.

Depending on the offer distributor 102, the offer distributor 102 may have or have available printing capabilities to mass distribute offers. It may also have databases and processors to distribute the offers over the internet or on paper or other media, preferably through targeting marketing.

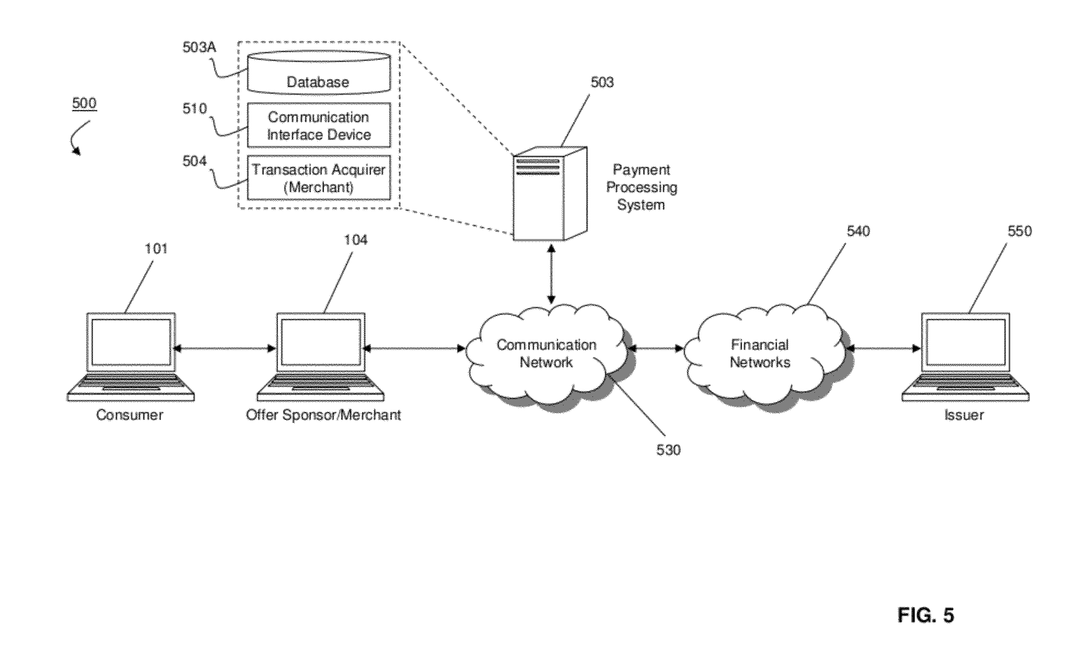

The payment processing network 103 processes transactions that use financial transaction cards by receiving authorization request from merchants through acquirers, in conventional manners and in manners described in the above-mentioned CPN Patents. Exemplary payment processing networks 103 include, but are not limited to, MASTERCARD, VISA, AMERICAN EXPRESS, DISCOVER, DINERS CLUB, etc., to name a few. The payment processing network 103 can communicate by two way communication to the offer distributor 102, the issuer, which might be the same or a different entity from the offer funding administrator 105, and the offer sponsor/merchant 104, both directly and/or through a transaction acquirer (see the transaction acquirer 504 depicted in FIG. 5). It includes a conventional card processing system and database 103D for routing to the appropriate issuer (see issuer 550 of FIG. 5) and sometimes processing of transactions (stand-in processing) for authorization. The payment processing network 103 also route authorization messages to the appropriate merchant, and other functions of a conventional payment processing system. Additionally, it might be set up to send transaction details and details about which entity (101, 102, 103, 104 and 105) is to get what type of consideration (financial compensation, like-kind compensation, discounts, rewards, etc.) stemming from a transaction. That is, each party (including the customer) to the transaction might receive a portion of the purchase of the product or service through the redemption of the coupon, and the payment processing network 103 could determine and facilitate this part of the transaction, or pass the necessary information on to the offer funding administrator 105.

The payment processing network 103 also has conventional UI and I/O devices, and though one is shown, it should be noted more than one payment processing network 103 can be used, and the actual system fairly complex with standing-in processing, routing, multiple exchanges, etc.

A merchant 104 offers goods and/or services and sponsors various offers for the merchant's products or services. It can communicate with the consumer 101 and the payment processing network 103, usually through an acquirer, via two way communications. The merchant 104 can be a brick-and-mortar business in which consumers 101 visit the merchant's facility, and more optimally a merchant 104 that has a presence on the Internet and is capable of e-commerce, complete with web servers and transaction processing computing devices and a database 104A, communicating via Hypertext Transfer Protocol (HTTP), Hypertext Transfer Protocol Secure (HTTPS), and other network communication protocols, for instance. It too has at least the conventional UI and I/O devices.

The merchant setup process captures the deal information including locations, timeframe, discount and validation of the token value used to validate the Groupon.

The VRS 103A may have the flexibility to limit a deal to a single merchant with one or multiple locations. By assigning the coupon an ITC number, inControl™ can validate the offer using the Acquirer ID (DE32) and Card Acceptor ID(s) (DE 42). The card acceptor ID is specific to the merchant location on the payment processor 103 authorization network. This will support a single merchant location model or a subset of locations for a multiple merchant location model.

Reporting can be based on the authorization logs captured by either payment processor 103 or funding administrator 105, and can provide information on offers sold and redeemed across all merchants—an important data element not available today. These can detail the authorization decision, the merchant and the date and time. Additional detailed reporting can be created using card processor (e.g., inControl™) APIs that would be specific to business requirements.

### II. METHODS FOR OFFER VERIFICATION AND REDEMPTION

Exemplary methods of offer verification and redemption shall now be described with reference to the several drawing figures.

A coupon for each customer receiving the coupon would have a unique ITC number created that is associated with a real card number on an issuer's platform. The real card number (RCN) would be an active account with the issuer with enough “open-to-buy” to support the total purchase amounts associated with all the vouchers associated with it. When the ITC number is received in VRS 103A for authorization approval these controls would be checked. If all the controls are validated the transaction would be forwarded to the issuer for their decision with the RCN as the PAN. If the controls are not validated the merchant would receive a decline response code from their acquirer and would not accept the Groupon as payment for services. If the issuer approves the transaction (fraud, open to buy, expiration date checks) the approval response is forward back to the merchant's POS via the acquirer.

Merchant ID/Location Rule—The VRS 103A can support different merchant rules within one coupon offer by using a merchant ID/Location rule to include indications of one or more of a merchant name, transaction acquirer ID, and card acceptor ID.

Offer Validity Immediacy—The VRS 103A can support the offer going “live” the moment the group threshold is reached, and consumers will not have to wait to begin using their voucher, thereby improving the consumer experience.

Offer Validity Period Rule—The VRS 103A can support different validity period rules within one coupon offer—if it is a desire to spread the effective date of the offer over a period of time that is advantageous to the merchant (e.g., a form of load balancing), the start and stop dates can be for example; the month of August for the ⅓ of the individual vouchers, September for the next ⅓ and October for the final third. Additionally, validation can be provided for a non-weekend or Monday night special offers using, for example: Tran Date>=Start date; Tran Date<=End date; Tran Date=End date.

Transaction Count Rule—this rule can be changed by the offer distributor 102 if there is a ‘user’ error. So if the user error dictates that they need a second swipe, the offer distributor 102 customer support person can up the counter in real time to ‘2’ and the merchant can run the validation again.

Spending Limits—this control can be used to limit the coupon to a validation only service in this case it would be set to the amount that ensures the transaction is routed to the VRS 103A. It can also be used to pay the merchant for their portion of the purchased coupon. In either case this can be an upper limit or an exact amount. In the cases of restaurants or other merchants where a tip is customary the tip amount is handled in the authorization by the merchant's processor.

Settlement of the coupon or voucher regardless of the amount may be a normal card settlement process between the card processor, funding administrator 105, the merchant acquirer and the merchant who processes the transaction. Settlement of funds would include interchange as dictated by the underlining product/transaction matrix. On a periodic basis (e.g., daily basis) funds for purchases would be transferred from the funding administrator 105 settlement account net interchange into the merchant acquirer's settlement account net interchange.

The individual voucher for each customer would be inserted into the VRS database 103c at the time the voucher threshold of customers is reached to activate the voucher by an offer distributor 102. Each customer 101 would have an ITC number uniquely assigned by payment processor 103 for each voucher they qualify for and is requested. So if the offer threshold was 50 for example, 50 VCNs would be requested by the deal distributor system with the same controls and loaded into the systems via Application Program Interfaces (APIs). The deal distributor 102 would receive back the ITC number with the confirmation of success for each request and they would associate that with the customer for live cycle customer servicing.

Connectivity into the VRS 103 may be SSL 128 bit encryption supporting the XML APIs with server based certificates issued for this service, for example. Collectively firewall rules would be executed to allow this TCP/IP traffic to flow between the payment processing system 103 and the deal distributor servers via the Internet by way of a non-limiting example. Additionally, if the funding administrator 105 wants a view into the VRS databases via the same APIs they would implement similar connectivity rules.

Offer Acceptance

In step 201, a consumer 101 accepts an offer from an offer distributor (D) 102. For example, a consumer 101 might receive a text message, e-mail, multi-media e-mail that informs him from its content or links to other content of a discounted offer (e.g., “50% off regular price at Suzy's Nail Salon for a manicure”).

In step 202, the offer distributor 102 requests an offer redemption code from an offer verification and redemption system (VRS) 103A. The offer redemption code may take the form and format of a financial transaction card (e.g., regular credit/debit/pre-paid card number or a virtual card number (VCN)). In other embodiments, the offer redemption code and the financial transaction card are distinct from each other. In the former, the offer redemption code can be used as the redemption code and as a VCN, e.g., as a stand-in for a regular credit/debit/pre-paid card number. In the later, the offer redemption code can be tied to a general offer (e.g., a widely distributed coupon or promotion code), whereas the ITC number can be specific to a given transaction.

As explained elsewhere, the offer distributor 102 receives payment from the customer 101, and that payment is used, at least in part, to apply funds to the ITC number that is returned to the customer for presentation to the merchant 104. Of particular usefulness is a purchase card (P-card) embodiment of an ITC number because the offer distribution 102 or the merchant 104 can act as a supervisory authority setting limitations on the ITC number use in accordance with the offer parameters and the customer can use the CPN within these parameters.

In addition to what is described above, the information returned in the APIs for the ITC number creation would provide the deal distributor 102 the ITC number the deal distributor 102 needs to print on the voucher PDF or include in the mobile app content, which also might provide the ITC number creation API as well. One exemplary solution is a real time solution, meaning as soon as the ITC number request is processed and confirmed on the VRS platform 103a, the deal distributor 102 can notify the customer of the offer and it can be used at the merchant. Additionally, when the voucher is used at the POS, an alert can be passed via SMS service to the deal distributor 102 to let the deal distributor 102 know the customer is satisfied and in the act of using their product. This would be useful for follow up offers via a mobile device, surveys or sharing information on the status of others offers, for example.

Based on the volumes and other business requirements a number of new bank identification numbers (BINs) would be provided and implemented on the payment processor's systems to be allocated for the ITC number for the vouchers. One BIN can handle over 900 million active ITC number concurrently. The actual number available is based on any qualifying business rules that would impose restrictions on digits 7-15 of the VCN. The actual number assigned to a customer's voucher is generated base on a preprogrammed scheme that all parties would agree to and validate as part of a particular implementation under one approach.

If the deal distributor 102 decides for whatever reason an active voucher needs to be cancelled, the APIs can be used to support that requirement.

For most cases the deal distributor 102 will have either a copy of the PDF or the raw data in their database to recreate the PDF for life cycle customer servicing. If the deal distributor 102 needs the details of an ITC number, there is an API to provide the details of an individual ITC number on the system.

Though called a funding administrator 105, a funding account is not required when the underlining account is a credit account. What is generally important is open to buy, available credit, on that account so the transactions regardless of the amount are approved by the issuer.

In an instance when the ITC number is declined or consumer would like a refund (low satisfaction), the VRS platform 103A may allow the deal distributor 102 to modify/cancel the ITC number in real time. All information about each voucher can be accessed by APIs or via the associated web based customer service platform. A consumer could inform the deal distributor's customer service representative about an issue, and depending on embodiment, a customer service representative could be able to change the rule for the utilization of the ITC number from “# of uses=1” to “# of uses=2” for example, while the customer is on the line.

When a financial transaction card is received for payment by a merchant, the merchant generally cannot tell whether it is an ITC number or a credit card number that represents the permanent account of the card holder. The ITC number is submitted (as explained below) to an acquirer that in turn submits the ITC number as part of a request for authorization for the transaction through a card processor 103 to the card issuer 105. At the card issuer 105 or at the card processor 103, if the financial transaction card is a VCN, it is identified (usually by the routing or BIN number forming the first few digits of the number) and the ITC number is mapped back to the regular account of the consumer 101, after (but alternatively this can be done later in the process) checking the ITC number against additional approval criteria (beyond the normal balance available/active card checks) which might include criteria set by the customer 101 is a normal operation. As will be seen below, here the system adds controls/usage limits specific to the particular offer so that it is good only for the particular offer and cannot be used for other types of transactions, for example. Pre-paid cards are similar to VCNs in that they can have unique numbers that can also be linked to controls on usage, and as a tracking number for specific transactions, for example, and can be modified to be associated with a particular offer, as explained below. Any form of ITC number that can be linked to information ancillary to the financial transaction card processing (such as funding account information), can be used, however.

VCNs as intelligent transaction card numbers can be requested one at a time or in batches. That is, an offer sponsor/merchant(s) 104 could buy multiple ITC numbers/redemption codes and distribute at will, or upon each desired transaction. Though generally the ITC numbers will remain virtual, it is also contemplated that they can be printed or embossed on cards or other forms of physical media for distribution to customers or potential customers 101.

ITC numbers/redemption codes are linked to offer funding accounts in a database 103D that is managed at a payment processing network 103. More specifically, the ITCs will be linked to offer funding account managed by the funding administrator 105. A customer's 101 credit card or other payment account can be used to load funds into the offer funding account managed by the funding administrator 105. So, the funding administrator 105 manages one (or more) offer funding accounts that contain the aggregate funding required to settle offer-related purchases. The offer funding account administrator 105 may but does not have to be the issuer of the regular credit cards or the ITC numbers. For instance, the offer funding account administrator 105 may manage funding account(s) to manage aggregate offer funding and may be configured at offer distributor 102. That is, the offer distributor 102 can be a service of the issuer of the credit card (see issuer 550 of FIG. 5) or the ITC numbers, or be a separate entity.

Usage limits for offer redemption code are included with this request. These limits are consistent with terms of offer (e.g., merchant, amount, time period of offer, etc.) that are determined by the merchant and implemented in the VRS 103A in this particular embodiment, but the usage limits can be set by the offer distributor 102, or perhaps even by the consumer 101 within parameters (a set-your-own price type offering). In the present non-limiting exemplary embodiment, the usage limits are stored in an offer redemption database 103B of the VRS 103A, which may be part of the normal payment processing network 103, or may be a separate entity, or a service provided at an issuer. The offer redemption database 103B permits the usage limitations be checked for validity before, concurrent with or after the ITC number is used to map the transaction details to an offer funding account of FA 105 for normal authorization processing. Additionally, offer descriptive data may be provided by the offer distributor 102. Examples of this data include offer code/name and consumer ID, to name a few. This data can be used to support value-added reporting services, such as facilitating targeted marketing, return on investment reporting, etc.

In step 203, offer acceptance is recorded in the offer redemption database (ORD) 103B. In a simple embodiment, ITC number's issuance indicates offer acceptance, but activation scenarios are contemplated, e.g., akin to gift card activation is instances where the ITC numbers/redemption code is distributed to potential consumers as part of the offer. ITC number spending controls, also referred to herein as usage limits, are established to bind ITC numbers to date/amount/merchant sponsor of offer. Other spending controls (e.g., merchant type, location, purchase frequency) may be employed for other offer types, and still other combinations of usage limits can be employed depending on offer parameters. Additionally the consumer 101, funding administrator 105 or merchant 104 might be given the opportunity to add his or her or its own controls that are not strictly required by the offer or its acceptance.

In step 204, the offer redemption code ITC numbers are returned to the offer distributor 102.

In step 205, the balance of offer funding account is incremented by cost of offer. This cost may be paid by consumer (using funding method of choice including payment accounts or points account) or another entity that has agreed to subsidize all/part of the offer cost.

In step 206, the offer redemption code/ITC numbers are provided to consumers. Provision of offer code may be via printed certificate, electronic certificate (e.g., mobile app, email, text) magnetic stripe payment card, NFC (Near Field Communication) enabled payment device (e.g., mobile phone), chip/smart card, QR 2D bar code or other device/media format that can be used to conduct payment processor-based (e.g., MasterCard-based) payments. Two amounts are provided as part of redemption code: offer value ($OV) and offer redemption amount ($ORA). $OV is the offer worth to the consumer. $ORA is the amount merchant is reimbursed for offer upon redemption payment request.

In alternate step alternate solution to having different $ORA and $OV is to leverage IPS (Integrated Processing Systems), pre-paid card processing or other ITC processing for remittance processing to facilitate the appropriate settlement across the offer distributor 102, the offer sponsor/merchant 104, the offer fund administrator 105 and the payment processor (e.g., MasterCard) 103. IPS could apply fees against cards and programs to facilitate needed charges and remittance to the involved parties, depending on implementation. IPS could receive payments requests, authorize the payment transaction, and apply appropriate fees. Alternatively or additionally, the necessary information could be passed onto another of the involved parties, such as the offer fund administrator 105.

Yet another alternative is to have an intelligent transaction code associated with controls for split payments. For example, payment to the merchant 104 can be divided up over time, one being at the offer acceptance (e.g., within 5 days of the sale), one sometime later (e.g., 30 days) and one even later (e.g., 45 days), for cash flow purposes. In fact, the intelligent transaction code could be set up at the time of acceptance that if various triggers (e.g., redemption or expiration) various parties could receive a portion of the offer as scheduled by the ORD 103A, for one example.

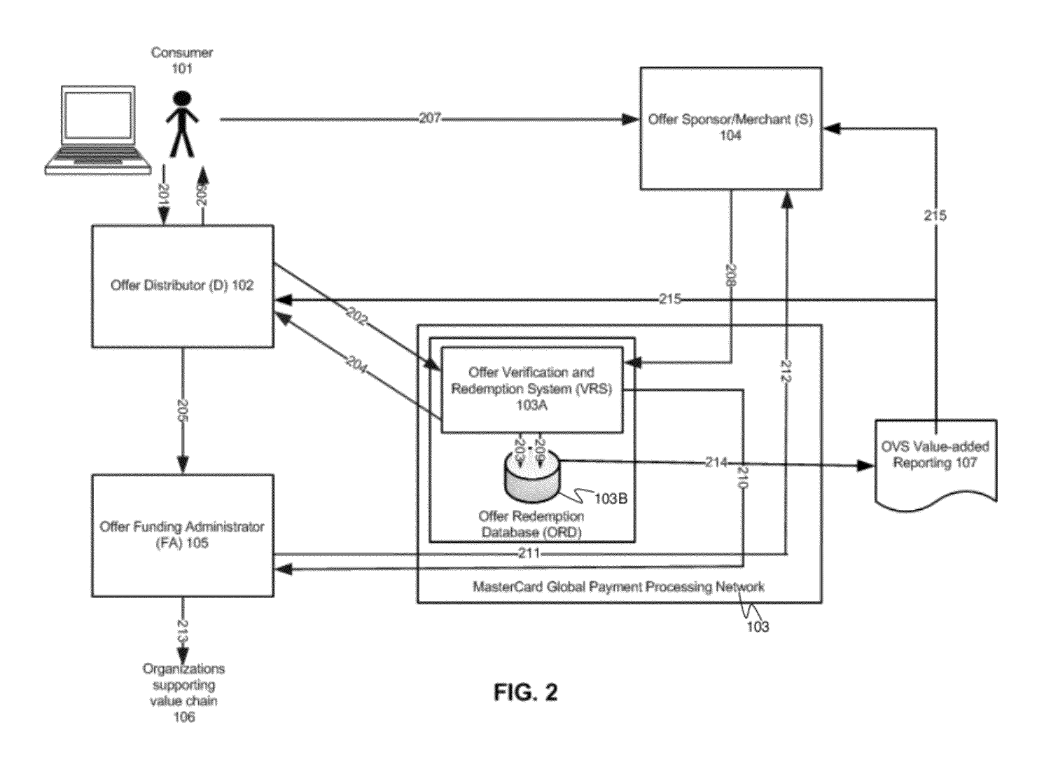

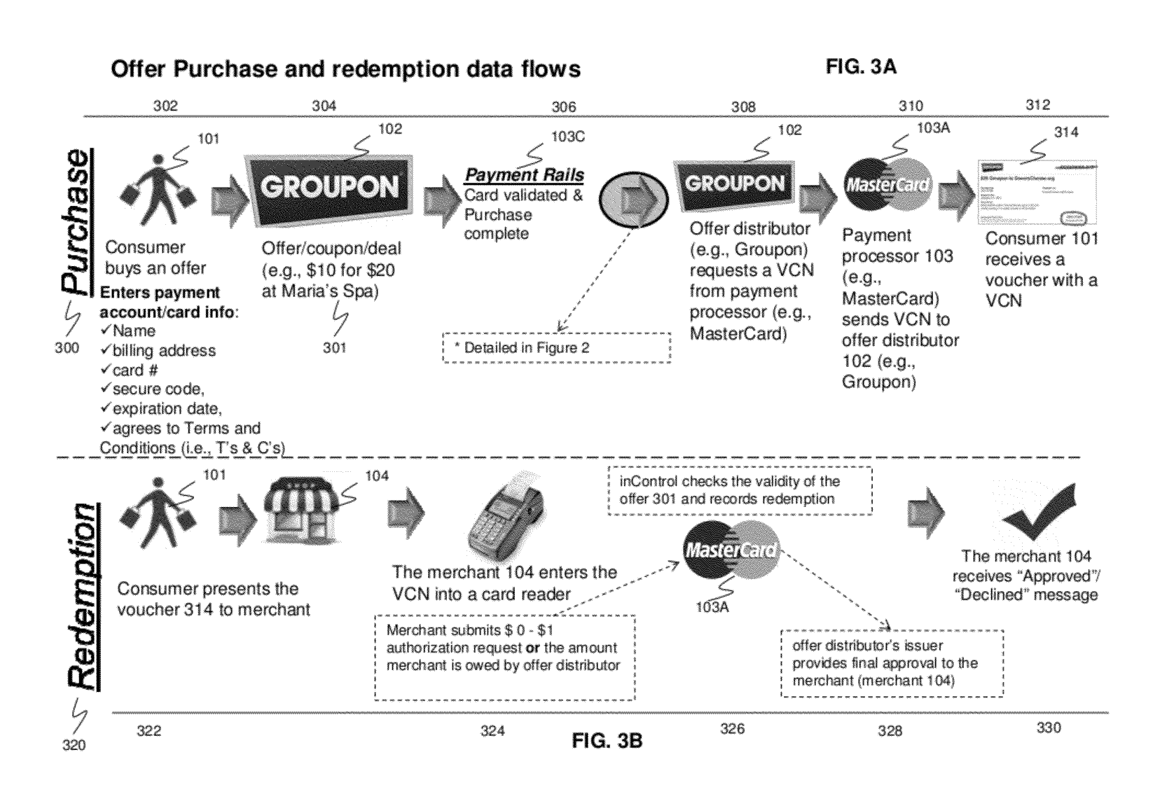

FIGS. 3A and 3B illustrate data flows for voucher purchasing and redemption processes, respectively. FIGS. 3A and 3B are described with continued reference to the embodiments illustrated in FIGS. 1 and 2. However, FIGS. 3A and 3B are not limited to those embodiments.

The offer processing using the purchasing process 300 of FIG. 3A and the voucher redemption process 320 of FIG. 3B is similar to transaction processing in that offers 301 need to be routed, tracked, validated, and approved.

As shown in the data flow diagram of FIG. 3A, the purchasing process 300 of purchasing a voucher 314 corresponding to a coupon or offer 301 includes the step of a consumer 101 buying 302 the offer 301. In the exemplary embodiment depicted in FIG. 3A, the buying 302 can comprise the consumer 101 entering payment account and consumer 101 information, such as, but not limited to the customer's 101 name, billing address, payment/card number, a secure code, and expiration date. Additionally, as shown in FIG. 3A, buying step 302 can comprise prompting the consumer 101 to agree to certain terms and conditions.

In Step 304, an offer distributor 102, such as, but not limited to, Groupon, sells a coupon for a certain value for goods and/or services from an offer sponsor/merchant 104. In the example of FIG. 3A, this step is illustrated as Groupon selling an offer 301 for ten dollars and the purchasing consumer 101 will receive twenty dollars of service at a merchant 104 (Maria's Spa in the example of FIG. 3A).

In Step 306, the card from step 302 is validated and the purchase is completed using the normal payment rails represented by the card processing system 103C described above with reference to FIG. 1, for example. As indicated in FIG. 3A, the details of the step after the card validation and purchase process are described above with reference to FIG. 2. After the payment processing has been completed by the card processing system 103C, purchasing process 300 proceeds to step 308.

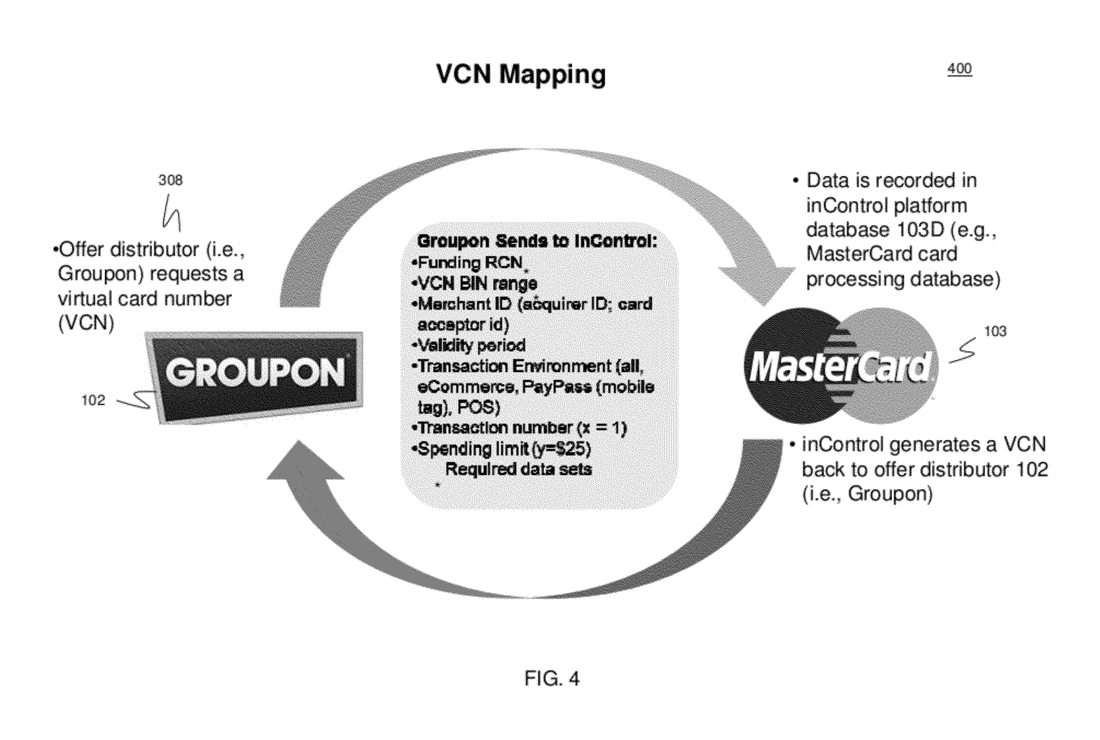

In step 308, the offer distributor 102 (i.e., Groupon in the exemplary embodiment provided in FIG. 3A) requests an ITC number from the offer verification and redemption system 103A. As shown in FIG. 3A, the offer verification and redemption system 103A can be implemented as MasterCard's inControl™ authorization system. Further details of the ITC number mapping process performed in this step are described below with reference to FIG. 4. The offer verification and redemption system 103A then sends the ITC number to the dealer/offer distributor 102, which in turn, in step 312, causes the coupon to be forwarded to the customer as a voucher 314 or the like that bears the VCN. It should be noted that in accordance with embodiments, the voucher 314 forwarded to and received by the consumer 101 in step 312 may be physical (i.e., paper or plastic), virtual (i.e., electronic), or nearly any other form suitable for delivery to the consumer 101. For example, in an embodiment, an indication of the voucher 314 can be received by the consumer 101 via a mobile application (‘mobile APP’) hosted on a mobile computing device associated with the consumer 101 (see, e.g., the mobile device 601 depicted in FIGS. 6 and 8).

FIG. 4 illustrates a data flow 400 for ITC number mapping wherein an offer distributor 102, such as, but not limited to, Groupon, requests an ITC number. FIG. 4 is described with continued reference to the embodiments illustrated in FIGS. 1, 2, 3A and 3B. However, FIG. 4 is not limited to those embodiments.

The ITC number mapping process 400 begins in step 308 when the offer verification and redemption system 103 is sent such data as the identity of the funding real card number (RCN), the ITC number (back identification number) arranged, a merchant identification for the merchant 104 and any other required ID, such as the card acceptor ID.

As shown in FIG. 4, the offer distributor 102 also sends a validity period, a transaction environment (all, ecommerce only, MasterCard PayPass®/mobile tag or POS, or combinations thereof) the transaction number, x. As illustrated in FIG. 4, x=1 if a single transaction is contemplated, and x will be more than one if more than one transaction is contemplated.

With continued reference to the embodiment of FIG. 4, the offer distributor 102 can additionally identify a spending limit y (i.e., $25 in the example of FIG. 4). As shown in FIG. 4, some of these data sets can be required for the ITC number mapping process 400, while others are optional. At the offer verification and redemption system 103 in conjunction with the offer redemption database 103A, data is recorded in the platform and the payment processing network 103 generates an ITC number for transmission back to the offer distributor 102 containing all of the appropriate controls.

FIG. 5 illustrates bi-directional communication within an offer processing system. FIG. 5 is described with continued reference to the embodiments illustrated in FIGS. 1, 2, 3A, 3B and 4. However, FIG. 5 is not limited to those embodiments.

FIG. 5 illustrates an overview of the computer architecture 100 of FIG. 1 within an offer processing system 500 including bi-directional communications between the components of the architecture 100 illustrated in FIG. 1 and the data flow illustrated in FIG. 2 with parties external to the architecture 100 for processing deal purchase and redemption transactions. As illustrated in FIG. 5, the offer processing system 500 includes at least a consumer 101, an offer sponsor/merchant 104, a transaction acquirer 504, an issuer 550, and a payment processing system 503. The consumer 101 engages in a financial transaction with the transaction acquirer (merchant) 104. Such financial transactions can be, for example, point-of-sale (POS) transactions, or transactions that are performed electronically, such as through the Internet. Types of consumer-merchant transactions that can be used in the offer processing system 500, as well as the information exchanged between the consumer 101 and merchant 104, will be apparent to persons skilled in the relevant art(s).

As illustrated in the exemplary embodiment of FIG. 5, a payment processing system 503 is configured to communicate with the merchant 104 and an issuer 550 via a communication network 530. Specifically, the payment processing system 503 receives specific transaction information pertaining to a financial transaction between the merchant 104 and consumer 101, which is transmitted through the communication network 530 upon initiation of a financial transaction related to a deal or offer. The payment processing system 503 processes the transaction by forwarding the transaction information through a particular financial network 540 and transmitting an authorization request to the issuer 550. The issuer can be, for example, a bank that had issued the credit card that the consumer 101 used in the financial transaction. The issuer 550 will then return either an authorization or denial of the financial transaction to the payment processing system 503 via the communication network 530. Once the payment processing system 503 receives authorization of the financial transaction from the issuer 550, and if the transaction information meets predetermined criteria, the payment processing system 503 is configured to transmit offer information via communication network 530 to the merchant 104. The offer information, in some embodiments, can be received via communication interface device 510 by transaction acquirer 504 and stored within the database 503A of the payment processing system 503. Thus, further communication between the offer distributor 102 shown in FIGS. 1 and 2 and payment processing system 503 could be limited. In other embodiments, the offers may not be released from offer distributor 102 until a financial transaction occurs, thereby triggering communication between the payment processing system 503 and the offer distributor 102.

As discussed above with reference to FIGS. 3A and 4 and in U.S. Provisional Appl. No. 61/586,049, entitled “Systems and Methods for Managing Overages in Daily Deals,” which is incorporated by reference herein in its entirety, the process of purchasing a coupon or voucher includes the customer buying an offer by entering such information as card information including name, billing address, card number, secure code, and expiration date and agrees to terms and conditions. An offer distributor 102 such as Groupon can sell a coupon for ten dollars and the consumer 101 purchasing the corresponding offer 301 will receive twenty dollars of service at a merchant 104, such as Maria's Spa. Next, a payment account (i.e., a card account) is validated and the purchase is completed using the normal payment mechanisms. An offer distributor 102 such as Groupon requests an ITC number (i.e., using step 308 as part of the ITC number mapping process 400 described above with reference to FIG. 4) from the offer verification and redemption system 103A such as MasterCard's inControl™. The offer verification and redemption system 103A then sends the ITC number to the dealer/distributor 102, which in turn causes the coupon to be received by the customer as a voucher or the like that bears the ITC number.

Offer Verification and Redemption

Having covered offer acceptance, now the offer redemption cycle will be described with continued reference to FIGS. 2 and 3A.

In step 207, a consumer presents offer redemption code (which may be an ITC number to a merchant 104 for payment of goods/services.

A consumer 101 presents the voucher 314 with an ITC number, expiration date, possible CVC value, and possible amount on it to the merchant 104 in order to redeem the offer 301.

The merchant runs a normal POS transaction using the deal administrator of information on the voucher 314 as input to their POS device. According to embodiments, this can include the ITC number, EXP date, CVC and amount to validate the offer 301.

In response to detecting receipt of the transaction, the VRS 103a will check the transaction data against the VRS database 103C and apply the rules encoded with that ITC number and validate the transaction. The ability to latch the exact merchant and location to the ITC number is controlled by the encoding in the terminal and information provided in the transaction by the merchants POS system and the acquirer prior to the transaction reaching the payment processor 103. The VRS 103A confirms the merchant is correct by comparing that information to the information provided in the original ITC number request when it is created. It is based on synchronizing the merchants/acquirer information between the ITC number creation and the POS transaction that ensures the voucher 314 is used at the correct merchant location and mitigates reuse or misuse for the deal distributor 102.

The merchant receives either an approval or a decline as to the validity of the voucher 314. These codes would be the same they receive today for their transactions.

Assuming the transaction is approved, the merchant 104 would complete that transaction and additionally complete whatever other transaction is required to finalize the purchase by the customer/consumer 101. The validation transaction would be cleared and settled by all parties as any other transaction the merchant ran that day. These monies would settle as business as usual (‘BAU’) via the four-parties (i.e., a merchant 104, a transaction acquirer 504, an issuer 550, and a consumer 101).

It is envisioned that the customer/merchant POS interaction could use barcode scans and other technologies that could automate the above process. As described above with reference to FIG. 3A, the voucher 314 could be presented via a mobile app, rather than on a piece of paper. This is the basic ‘keyed’ interface, but not the only interface.

Generally, the deal distributor 102 does not participate in the validation process, except for customer service issues. The funding administrator 105 will still receive the authorization from the card processor 103 and will need to make a decision in order for the card processor 103 to forward the approval to the POS. The funding administrator 105 could decline the transaction as needed.

This system does not require any upgrades or additional systems or hardware for this basic solution.

In one embodiment, the offer sponsor/merchant 104 reduces total purchase amount by the offer value.

In step 208, the offer sponsor/merchant 104 submits offer redemption payment request using offer redemption code. The amount of this request will be $ORA. The redemption code/ITC number may be used for partial payment of entire purchase amount. In this case, the offer sponsor/merchant 104 will request additional payment method for remaining balance of purchase amount.

In step 209, the VRS 103A verifies offer validity using offer redemption code submitted by the offer sponsor/merchant 104 along with offer details captured in step 202 of offer acceptance process. The VRS 103A will also ensure that offer redemption is consistent with offer terms specified by the offer distributor 102 (e.g., max number of uses). The VRS 103A will reject offer redemption payment requests for invalid offers or for purchases which do not meet offer terms as specified by the offer distributor 102. The VRS 103A identifies appropriate offer funding account at the offer funding administrator 105 based on the ITC number/funding account link or mapping established in step 202 of offer acceptance process. See, e.g., the CPN Patents for further details of this process.

In step 210, the payment processing network (e.g., MasterCard network) 103 forwards payment requests to the funding administrator 105. The funding administrator 105 processes request and reduces balance of offer funding account by $ORA. The funding administrator 105 responds to the payment processing network 103 with processing confirmation and approval. The payment processing network 103 responds to the offer sponsor/merchant 104 with approval of offer redemption payment request. $OV−$ORA=offer margin. This margin is shared by the organizations supporting the value chain as per agreed terms. Of course, this is only one way that each of the various entities can receive consideration. The service can be subscription rather than usage based, or combinations of various compensations mechanisms.

To summarize, as shown in FIG. 3B, the redemption process 320 includes the customer presenting the voucher to a merchant (322) and the merchant enters the ITC number into a card reader in Step 324. The Step 324 can include the merchant submitting anywhere from zero to a dollar off of an authorization request, or the amount the merchant 104 is owed by the offer distributor 102 such as a daily deal provider. In Step 326, the offer verification and redemption system 103 (e.g., inControl™ by MasterCard) checks the validity of the offer and records the redemption which, as explained in greater detail with respect to FIG. 2 involves authorization 212 being sent from the offer funding administrator 105 to the merchant 104 (e.g., Groupon's issue or provides final approval to the merchant). In step 330, the merchant receives an “approved/declined” message as a result.

In an embodiment, the redemption process 320 can be implemented as a local offer redemption service using an authorization system such as MasterCard's inControl™ authorization system with an ITC number. This local offer redemption service can be a turnkey solution to deliver rebates on authorization/clearing data as part of a seamless process with clean and qualified data. According to this embodiment, the redemption process 320 is effective to reward a consumer 101 through card-linked offers 301.

In another embodiment, the redemption process 320 can include rebate services as part of card linked offer redemption using a reward services platform, such as, but not limited to the MasterCard Rewards Services (MRS). Such rebate services can combine features of MRS with MasterCard's inControl™ authorization system. This embodiment incorporates MRS card registration, thus expanding options for future deal offerings. The rebate services streamline the redemption process 320 with instant availability and mobile distribution of offers 301 while also capturing relevant deal metrics for the offers 301 and their associated vouchers 314 with minimal disruption to the consumer 101 and merchant 104 experiences.

The redemption process 320 can also collect baseline metrics for program performance (e.g., offers 301 sold and redeemed). In an embodiment, some baseline metrics can vary across redemption products (e.g., card linked offer redemption will include an average ticket value while the local offer redemption service will not.

Offer Settlement

Merchant systems will submit successful validations for vouchers 314 to the payment network 103 for settlement. The transaction amount will be nominal (a penny or 10 cents) and may match the amount that was configured for this offer. Since standard settlement processes will be followed the nominal amount will be sent to the merchant. This amount is above and beyond what the customer paid for the voucher. The merchant was paid for the value of the deal directly by the deal distributor.

As indicated in FIG. 3B, in one embodiment, the voucher 314 is proposed to have a small nominal value; as such the funding administrator 105 will pay the merchant 104 via a normal payment processor settlement service as they do for all purchases on their issued cards the purchase amount net interchange. The deal distributor 102 would not normally receive nor pay funds as part of the voucher usage on the network in this example. Since the credit account at the funding administrator 105 is typically a customer or corporations liability, the funding administrator 105 has to consider if is going to statement and collect those funds.

Having described offer acceptance and offer verification and redemption, the offer settlement process will now be described with continued reference to FIG. 2.

In step 211, the offer funding administrator 105 settles with the payment processing network 103 for the amount $ORA, for example.

In step 212, the payment processing network settles with the offer sponsor/merchant 104 for $ORA. The offer sponsor/merchant 104 receives settlement funds via existing payment processing network 103 settlement process and, within existing payment processing network settlement timeframes, in this particular non-limiting embodiment.

In step 213, the offer funding administrator 105 shares offer margin amount with other parties 106 supporting the value chain in this embodiment, though other compensation mechanisms can be employed. Settlement of these funds may occur via mutually agreed process. Parties settled across include the offer distributor 102 (which can be multiple parties e.g., deal originators, deal aggregators, and deal publishers), offer sponsor/merchant 104, VRS 103A independently or as part of the payment processing network 103 and offer funding administrator 105.

In addition or alternatively, an intelligent transaction code (e.g., ITC number) can be processed by the card processing system 103C as part of the authentication or redemption for a nominal amount to verify the intelligent transaction code is live and can be used. This nominal amount may be equal to the compensation to be paid to one or more players (e.g., the payment processing network 103 for example.

Offer Reporting

Having described the process through offer settlement, various reporting functions will now be described with continued reference to FIG. 2.

In step 214, offer acceptance and redemption data is collected in the VRS 103A database 130B. This data empowers value-added reporting by the offer verification service (OVA) 107 for the offer sponsor/merchant 104 and the offer distributor 102, and perhaps for lease, usage or sale to various third parties.

In step 215, value-added reports are distributed to the offer sponsor/merchant 104 and/or the offer distributor 102 in this exemplary embodiment. Reports may also employ transaction processing data for secondary payments, payment of additional fees not tied directly to the deal offer value, such as fees for collateral and convoyed sales whether at the same time or thereafter, rewards for attracting new repeat customers or customers for new co-branded cards, to name a few possibilities. These can be based on the transaction using the ITC number supplied with or as the redemption code, through surveys or other forms of human reporting, or through use of co-branded or loyalty cards or promotion programs that tend to track sales that can be linked to acceptance of the initial offer in whatever manner. This will enable OVA to quantify sales “uplift” benefit to the offer sponsor/merchant 104.

The notification to the deal administrator of the usage could be an after-the-fact process, the funding administrator 105 could ‘tell/alert’ the deal distributor 102 when they approve the transaction via any one of several methods, including batch reports or single messages via a web interaction. Additionally both the funding administrator 105 and the deal distributor 102 can query the VRS data base 103c and receive usage information. However the notification process could also be real time using an SMS service to send and SMS message to a deal originator server. This has many positive customer service potentials.

Fraud or voucher audit controls are inherent in this solution as each ITC number will have rules that would be designed to meet requirements of the deal distributor 102 and/or the fund administrator 105. Controls can lock the voucher down to a very singular usage footprint that it will severely hamper the customer or the merchant from abusing the system. VRS platform 103A will check that the voucher number has not been used previously, as well as validate the merchant's name, location and offer amount.

Trouble shooting and processing auditing can be done with the same underlining APIs to gain access to the data. Additionally, a web based servicing platform can be used in a call center to do transaction level research on an ad hoc basis.

Transaction reports will be available via several methods. The funding administrator 105 will have a record of all the approved and declined voucher validation transactions. Information in some form might be shared with the deal distributor 102 for integration into their existing reporting systems. The VRS 103 can be used to report on the individual voucher on an ad hoc basis as needed to support customer service functions. This service will allow for a full range of operational and MIS reports. Initially these might be transactional in nature and would include information that would indicate counts, amounts and percent utilization etc. These will be offered as standard reporting with the service.

Additionally one might create analytical and market assessment type reports. These would leverage the mentioned data as well as data points that only our warehouse can uniquely derive and interpret.

Consumer Interface and Database

In addition to the data flows and processes described above, there may be additional components provided as part of the technical solution.

Database: in the exemplary embodiment depicted in FIG. 2, an offer redemption database (ORD) 103B can be configured to store database records corresponding to information generated by the VRS 103A at an individual consumer level (i.e., for each consumer 101). It can also store individual consumer information relating to merchant or category preferences, zip code, gender, propensity scores, transaction data, and program permissions. Database can also be matched with other data sources for purposes of refining targeting, reporting and analysis.

Targeting services provided could include targeting for program acquisition or ongoing marketing based on category preferences, zip code, gender, propensity scores, other data sources, and social media information (e.g., offers that friends liked).

A consumer interface: in embodiments, consumers 101 can access offers 301 as part of a website, mobile app, electronic wallet, or other means. The consumers 101 can also retrieve information on offers available, offers purchases, offers redeemed, total amount spent to date. For example, such retrieval can be accomplished using one or more mobile apps hosted on a mobile device 601 associated with a consumer 101.

Offer Marketing and Communications

The system depicted in FIGS. 1 and 2 can send a real time communication (text alert, email, app push alert) to consumers from the offer distributor 102 or the offer sponsor/merchant 104 with messaging based on offer code or other analytics. Communication could service multiple purposes, including: offer use “confirmation,” a call to action to make an additional purchase with the offer sponsor/merchant 104 or the offer distributor 102 or any related merchant (e.g., you've just enjoyed dinner, why not get dessert across the street”), customer survey to solicit feedback, call to action to share information relating to the program, offer or other information with friends via social means (e.g., to post on Facebook “I just had a great meal at Tony's Pizza”) or email.

Leveraging OVS 107 and database information, system could also be leveraged to send offers or information to consumers at other times via multiple means including text, application notice or email. These messages could be targeted based on past transaction history, offers the consumers “friends” liked, offers their friends have used, etc. Sample message would be “Other users like you have really enjoyed this offer,” or “We miss you, and here is a special offer from the offer distributor 102 and/or offer sponsor/merchant.”

Additional Design Elements/Considerations

According to some exemplary embodiments, a redemption solution leveraging intelligent coupon numbers (ITCs) and intelligent coupon numbers (ICNs) can be part of a larger, integrated solution, including but not limited to:

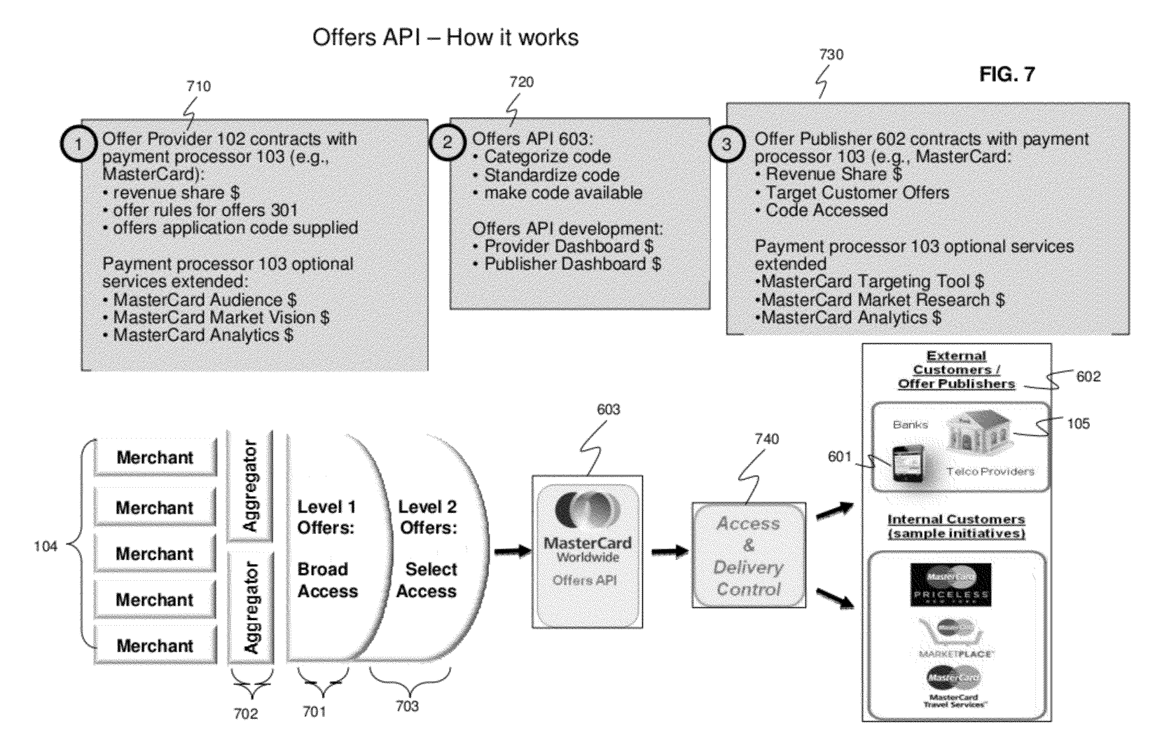

1) Offer targeting (see, e.g., FIGS. 6 and 7) provided for both customer activation and new customer acquisition, as well as refining the types of offers 301 shown or pushed to a given customer;
2) Comprehensive return-on-investment (ROI) reporting for campaigns (e.g., offers 301 bought/redeemed, average ticket, purchase above offer amount (i.e., overage), percentage of new customers 101, etc.);
3) “Consumer Central” (a consumer front end) where the payment processor network 103 stores personally identifiable information (PII) and permissions from consumers 101, giving the payment processing network 103 rights to re-market to consumers 101; and
4) Pricing which provides additional motivation for consumers 101, merchants 104, and deal aggregators (see aggregators 702 in FIG. 7) for transacting with the payment processing network 103.

The present inventors envision the redemption solution being deployed in various forms such as, but not limited to:

1) intelligent coupon numbers (ICNs) on a paper coupon and card payment;
2) ICNs on a mobile device 601 and card payment; and
3) ICNs in a mobile wallet and/or a mobile payment.

The business model can be profit-sharing: when settlement occurs, the split can occur between the merchant and aggregator, with the payment processing network also receiving some consideration.

Fully leveraging the offer data can be done in phases, depending on how seamlessly the redemption process is integrated with consumer enrollment. For example, at first the payment processing network 103 may have no ability to tie the redemption of the offer 301 to a specific enrollee and their redemption code number; a deal aggregator 702 would get immediate benefits with less reliance on paper to effect redemption and track results, less fraudulent misuse/re-use of offers 301, and quicker access to their share of the settlement split; and a merchant 104 gets immediate benefits of easier redemption process by using conventional card network, quicker receipt of funds from settlement.

In an alternative embodiment, the payment processing network 103 can own the consumer front-end and resulting database. This approach provides the ability to tie offers 301 to specific consumers 101 (tying ITC numbers to the redemption code numbers of the consumer), provide the potential for capturing incremental spend (above offer value), improving targeting models, especially for customer activation, and providing a merchant portal allowing merchants to access select data, to name a few benefits.

FIG. 6 illustrates how a payment processor can act as a distribution hub for developers to present and create offers applications for consumers so that offer providers can target offers for syndication. FIG. 6 is described with continued reference to the embodiments illustrated in FIGS. 1 and 2. However, FIG. 6 is not limited to those embodiments.

As shown in FIG. 6, in an embodiment, one or more offer distributors/providers 102 that want to target specific offers 301 for syndication can do so via calls to an offers application programming interface (API) 603. By using the offers API 603, offer publishers 602 can target relevant offers 301 from merchants 104 to consumers 101. In this way, the offers API 603 enables merchants 104 and offer providers 102 to develop relationships to source offers 301 at scale for internal and external customers. In embodiments, such internal and external customers can include issuers 550 and telecommunications companies (telcos) such as, but not limited to Sprint, and banks 105 such as Citibank. Use of the offers API 603 can reduce complexities of data integration and thus hasten a speed to market for targeting offers 301 to consumers 101.

As indicated in FIG. 6, by using the offers API 603, a payment processor 103 (e.g., MasterCard) can act as a distribution hub for developers to present and create offers applications for consumers 101. In this way, the payment processor 103 can leverage scaled distribution of offers applications (i.e., via mobile apps installed on mobile devices 601) from issuers 550, merchants 104, offer providers 102, telcos, offer publishers 602, banks 105, and other entities.

FIG. 7 illustrates features and functionality of the offers API. In particular, FIG. 7 illustrates how the offers API 603 works to deliver level 1 and level 2 offers 701 and 703 from a plurality of merchants 104, via offer aggregators 702 to external and internal customers. FIG. 7 is described with continued reference to the embodiments illustrated in FIGS. 1, 2 and 6. However, FIG. 7 is not limited to those embodiments.

As shown in FIG. 7, in step 710, an offer provider 102 can contract with payment processor 103 (e.g., MasterCard) for services including, but not limited to: revenue sharing, implementing offer rules for offers 301, and supplying code for an offers application. These offers applications can then be executed on one or more mobile devices 601 associated with consumers 101. In an embodiment, the payment processor 103 can optionally extend services including MasterCard audience, MasterCard Market Vision reports, and MasterCard Analytics.

In step 720, the offers API 603 categorizes and standardizes code so that there are common standards among parties such as the merchants 104, the aggregators 702 the offer providers 102 and the offer publishers 602. This step also comprises using the offers API 603 to make the code available. Such code can be code for offer application(s). Advantageously, the offers API 603 can provide code and targets to the offer providers 102, create uniform code access for easy and flexible deployment of offer application(s), provide the offer publishers 602 with access to the code and targets. In this way the offers API 603 enables use of common standards amongst parties such as the offer publishers 602 and the offer providers 102, which in turn enables these parties to develop fast and flexible offer applications (speed to market) while also enabling the customer/consumer 101 to control offer selection. The offers API 603 also enables tracking and reporting to optimize return on investment (ROI) for offers.

As part of step 720, the offers API 603 development can also implement dashboards for offer providers 102 and offer publishers 602.

In step 730, an offer publisher 602 can contracts with a payment processor 103 (e.g., MasterCard) for one or more of the following: revenue sharing, targeting customer offers 301, and accessing offer application(s) code. In this step, the payment processor 103 can optionally extend services for an offer targeting tool, market research, and MasterCard Analytics.

As indicated in FIG. 7, in embodiments, some of the contracted services and optional services extended in steps 710-730 can be provided as value-added services on a fee basis (denoted by dollar signs in FIG. 7). Some of these are can be purchased as ‘a la carte’ additional services from entities external to the offer distributors 102, merchants 104 and offer publishers 602 (e.g., MasterCard Advisors). In an embodiment, an additional revenue stream for selling base line redemption services (i.e., services to enable the redemption process 320) so as to provide redemption metrics and reporting, fraud prevention, consumer communication and settlement services enabling streamlined accounting (accounts payable) and use of secure payment methods.

In another embodiment, step 730 can include revenue sharing and collection of commission revenue from offer publishing through internal and external customers. For example, step 730 can comprise selling access to a large distribution network to offer providers/distributors 102 who will have the convenience of using the offers API 603 to connect to a distribution network to distribute offers 301. This step can also comprise providing, on a fee basis, access to large inventory of offers 301 across multiple categories and types of merchants 104 to offer publishers 602.

By completing steps 710-730, the offers API 603 enables a plurality of merchants 104 to enable access to and deliver level 1 offers 701 (i.e., offers 301 intended for broad access by many consumers 101, and level 2 offers 703 (i.e., offers 301 intended for select access by targeted groups of consumers 101). The level 1 offers and level 2 offers 703 are aggregated by offer aggregators 702 before the offers API 603 is invoked.

With continued reference to FIG. 7, access and delivery controls 740 can facilitate providing access to and delivery of a plurality (i.e., hundreds or thousands) of offers 301, which can comprise level 1 offers 701 and level 2 offers 703, that can be leveraged by internal and external customers. As indicated in FIG. 7, these internal and external customers can include banks 105, telco providers and internal customers of the payment processor 103.

FIG. 8 depicts offer validation and tracking features of a technical solution for marketing control for the deal purchasing and redemption processes described above with reference to FIGS. 3A and 3B.

In particular, FIG. 8 illustrates how electronic controls can be set for offers 301 by using the marketing control solution in conjunction with step 308 of the offer purchasing process 300. As indicated in FIG. 8, the marketing control solution also establishes a platform to optimize the settlement process and provides an initial step towards implementing a broader marketing plan within the context of the purchasing process 300 and the redemption process 320. By incorporating the marketing control solution into the purchasing process 300, instant usability of an offer 301 via an electronic voucher forwarded to a mobile device 601 associated with a consumer 101 is enabled.

FIG. 8 also depicts how backward compatibility with existing card readers and POS terminals at merchants 104 can be achieved when the marketing control solution is incorporated as part of the redemption process 320. For example, the marketing control solution can provide access to MasterCard inControl™ via an API to create unique intelligent coupon numbers (ICNs) to be used as offer codes so that no changes to a merchant's POS are needed. Additionally, the marketing control solution provides the ability to set verification controls for each ICN for each consumer 101 in addition to enabling overage tracking by providing an ability to track the full amount of a purchase (vs. only the value of the offer 301), which can help merchants 104 appreciate the full value of a deal/offer campaign. In an embodiment, the marketing control solution also includes a status API, which provides the ability to “push” a status of an ICN and conduct ‘up sell’ and other communications to consumers 101.

As shown in FIG. 8, the marketing control solution also streamlines the voucher redemption process 320 by tying the redemption process 320 and offer validation together. The marketing control solution captures deal metrics relevant to the merchants 104 and the deal providers/offer distributors 102. In the embodiment of FIG. 8, these capture metrics can then be stored in a data store of the offer verification and redemption system (VRS) 103A as part of step 326 of the redemption process 320.

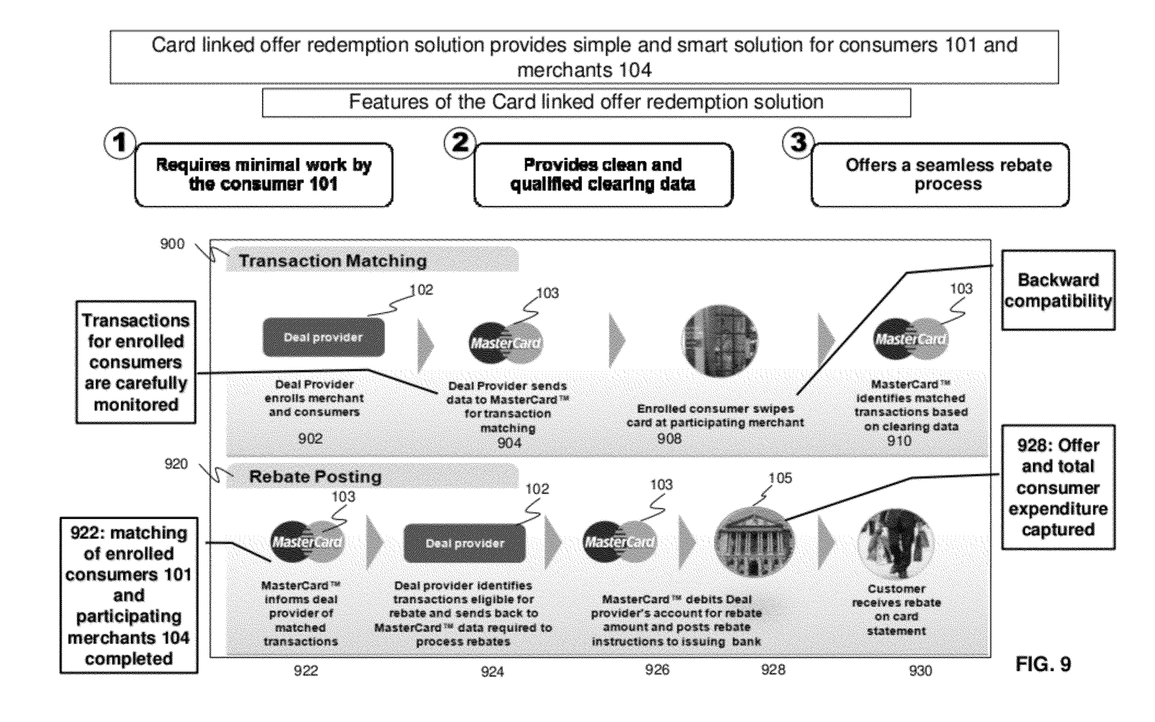

FIG. 9 illustrates features of a technical solution for card linked offer redemption. In particular, FIG. 9 illustrates respective steps of processes for transaction matching 900 and rebate posting 920.

As shown in FIG. 9, in an embodiment, the processes for transaction matching 900 and rebate posting 920 provide a simple and smart solution for consumers 101 and merchants 104. The rebate posting process 920 offers a seamless rebate process for payment accounts/cards and merchants 104. The card linked solution is ‘smart’ in that it informs offer providers/distributors 102 when a consumer 101 has made a qualified transaction at a merchant 104. The rebate posting process 920 illustrated in FIG. 9 also provides improved messaging capabilities that provide consumers 101 with instant confirmation of a discount being processed. By using the rebate posting process 920, a consumer 101 needs no coupons at a merchant's POS because the discount automatically happens.

As indicated in FIG. 9, the features of the card linked offer redemption solution include requiring minimal work by the consumer 101, providing clean and qualified clearing data, and offering a seamless rebate posting process 920.

The transaction matching process 900 steps are described below with continued reference to FIG. 9. The transaction matching process 900 provides the ability to recognize a qualified offer 301 linked to a purchase in real time and provide a discount at a merchant's POS.

In step 902, a deal provider/distributor 102 enrolls merchants 104 and consumers 101 before passing control to step 904. In step 904, transactions for enrolled consumers are carefully monitored and the deal provider 102 sends data to a payment processor 103 (e.g., MasterCard) for transaction matching. In an embodiment, a MasterCard universal ID can be used as part of step 902 to deliver a better consumer experience by simplifying the consumer 101 registration/enrollment process.

In step 908, after the transaction matching, consumer 101 enrolled in step 902 swipes a card at a participating merchant 104. As shown in FIG. 9, step 908 ensures backward compatibility with existing merchant systems by allowing the consumer 101 to swipe his payment account card at the merchant's POS (e.g., at an existing POS terminal).

In step 910, the payment processor 103 (MasterCard in the exemplary embodiment of FIG. 9) identifies the matched transaction based on clearing data.

The rebate posting process 920 steps are described below with continued reference to FIG. 9.

In step 922, matching of enrolled consumers 101 and participating merchants 104 is completed and the payment processor 103 (e.g., MasterCard) informs the deal provider 102 of the matched transactions before passing control to step 924.

In step 924, the deal provider 102 identifies transactions eligible for rebate(s) and sends back to the payment processor 103

### III. METHODS FOR DYNAMIC GIFT CARD GENERATION AND REDEMPTION

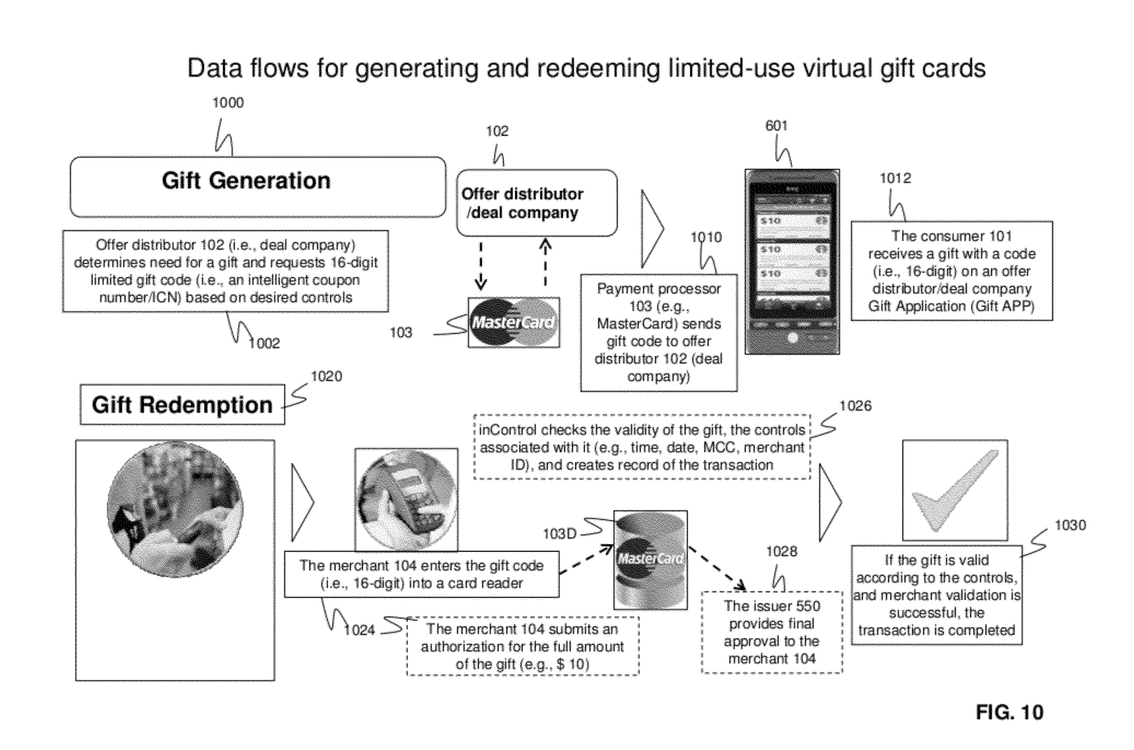

FIGS. 10-12 illustrate features and steps of methods and data flows for generating and redeeming dynamic gift cards, which can be implemented using similar data flows described above with reference to the offer purchase process 300, voucher redemption process 320, transaction matching process 900, and rebate posting process 920 described with reference to FIGS. 3A, 3B, and 9 above.

FIG. 10 is a data flow diagram depicting steps for generating and redeeming dynamic, limited-use virtual gift cards. In particular, FIG. 10 illustrates data flows and steps by which dynamic, limited-use gifts are generated and redeemed by completing processes for dynamic gift card generation 1000 and redemption 1020.

The steps for the dynamic gift card generation 1000 process are described below with reference to FIG. 10.

In step 1002 an offer distributor 102 (i.e., a deal company) determines a need for a gift and requests a 16-digit limited gift code (i.e., an intelligent coupon number/ICN) based on desired controls. These controls can be set by a consumer 101 who initially purchases the gift (i.e., the giver/purchaser). In most cases, the giver/purchaser will give the gift to another consumer 101 (i.e., the gift recipient) who will ultimately redeem the gift. According to embodiments, the purchaser can select either a total or maximum monetary value for the gift as one of the controls. In embodiments, the controls can also include, but are not limited to constraints on: using the gifts at specific merchant locations; using the gift for specific merchant categories (i.e., based on merchant category codes/MCCs assigned to a merchant 104); using the gift for certain types of goods or services (i.e., in order to cap a percentage or monetary amount of the gift that can be used for beverages vs. food at a dining establishment); and/or time of usage (i.e., time of day, day of week, and expiration date).

As shown in FIG. 10, step 1002 involves an exchange of communications between the offer distributor 102 and the payment processor 103 (MasterCard in the exemplary embodiment of FIG. 10) where the communications include indications of the controls. In an embodiment, these controls can be dynamically altered after the gift has been forwarded to an intended recipient such as a consumer 101, but prior to the redemption of the gift. In another embodiment, such dynamic alteration of the gift controls can be performed by one or more parties, such as, but not limited to, a purchaser/giver of the gift (i.e., a consumer 101 other than the gift recipient), an offer distributor 102, a merchant 104, or a payment processor 103. In yet another embodiment, the controls can be altered after a portion of the gift has been redeemed at a merchant 104 (i.e., in cases where only part of the total value of the gift has been used by a consumer 101) for any remaining balance for the gift. In embodiments, the controls can constrain recipient consumers 101 to redeeming the gift on specific days, such as a birthday or anniversary, or geographic locations and regions, such as city, state/province, country, or continent.

In step 1010, the payment processor 103 (e.g., MasterCard) sends a gift code to offer distributor 102 (i.e., the deal company) before proceeding to step 1012 where the consumer 101 receives a gift with the gift code (i.e., 16-digit code obtained in step 1002) via an offer distributor 102/deal company gift application (Gift APP). In the exemplary embodiment of FIG. 10, step 1012 comprises forwarding an indication of the gift and the gift code to a Gift APP running on a mobile device 601 associated with the consumer 101 (i.e., the intended recipient of the gift). In alternative embodiments, the gift and gift code can be conveyed as a paper voucher (i.e., similar to voucher 314) a plastic gift card, an email message, a Short Message Service (SMS) text message, or other suitable communications means.

At this point, the received gift is ready to be redeemed by a consumer 101. The steps for the dynamic gift card redemption 1020 process are described below with continued reference to FIG. 10.

In step 1024, a merchant 104 enters a gift code (i.e., a 16-digit code) into a card reader. In an embodiment, this step comprises the merchant 104 submitting an authorization for the full amount of the gift (e.g., $10) to an offer funding account in a database 103D that is managed at the payment processing network 103.

In step 1026, inControl™ checks the validity of the gift, the controls associated with it (e.g., time, date, MCC, merchant ID), and creates record of the transaction before passing control to step 1028 where the issuer 550 provides final approval to the merchant 104.

At this point, in step 1030, in response to determining that the gift is valid according to the controls checked in step 1026 and that merchant validation based on the controls was successful, the gift redemption transaction is completed.

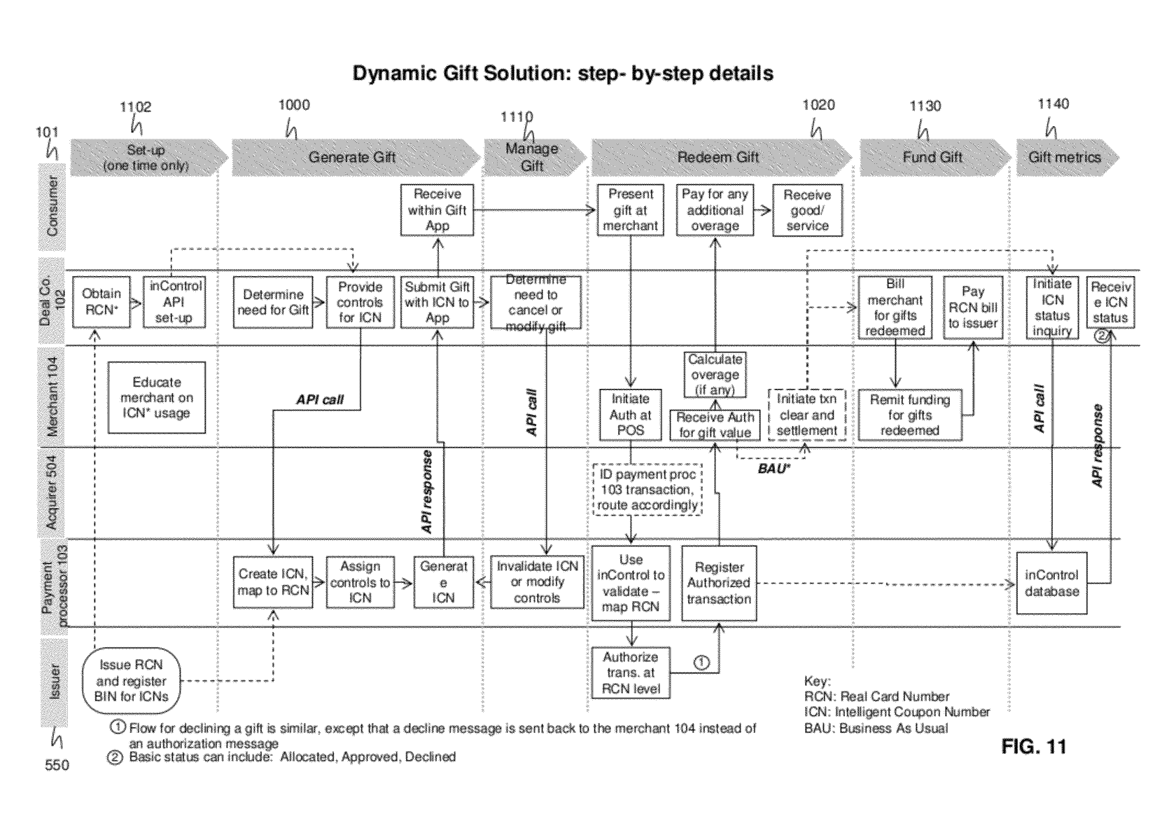

FIG. 11 is a flowchart depicting steps by which the dynamic gift cards are generated, managed, redeemed, and funded. In particular, FIG. 11 depicts the step-by-step details for steps by which various entities perform processes for setting up, generating, managing, redeeming, and funding limited-use dynamic gifts. FIG. 11 also illustrates the detailed sub-steps of step 1140 for collecting metrics for a limited-use dynamic gift. FIG. 11 is described with continued reference to the embodiments illustrated in FIGS. 1, 2, 5, 6 and 10. However, FIG. 11 is not limited to those embodiments. The steps of the dynamic gift card methods shown in FIG. 11 do not necessarily have to occur in the order described. Further, as described below and indicated by the dashed lines in FIG. 11 some of the steps are optional.

As shown in FIG. 11, in an embodiment, the following entities/parties each play roles and are responsible for performing sub-steps for setting up, generating, managing, redeeming, and funding limited-use dynamic gifts: a consumer 101, an offer distributor 102 (i.e., deal company/deal provider), a merchant 104, a transaction acquirer 504, a payment processor 103 (e.g., MasterCard), and an issuer 550.

In the embodiment depicted in FIG. 11, each of the above-noted entities and parties are responsible for various steps and stages of the following processes for setting up, generating, managing, redeeming, funding, and collecting metrics for limited-use dynamic gifts: a one-time set-up 1102, dynamic gift card generation 1000 (described above with reference to FIG. 10), gift management 1110, dynamic gift card redemption 1020 (also described above with reference to FIG. 10), gift funding 1130 and collection/storage of gift metrics 1140.

The detailed steps for each of the above-noted processes are described below with continued reference to FIG. 11.

As part of the one-time gift set up 1102, according to the embodiment depicted in FIG. 11, the issuer 550 issues a Real Card Number (RCN) and registers a Bank Identification Number (BIN) for an Intelligent Coupon Number (ICN). Next, an offer distributor 102 obtains the issued RCN and then sets up an inControl™ API as part of the one-time set-up 1102. As shown in FIG. 11, the merchant 104 is also educated on use of the ICN as part of the one-time set-up 1102.

The gift generation process 1000 comprises the steps and stages described below. First, a payment processor 103 such as MasterCard creates an ICN and maps it to the RCN issued during the one-time set-up 1102, assigns controls to the ICN based on an API call from the offer distributor 102 (i.e., the deal company/deal provider). As shown in FIG. 11, this API call serves to provide controls for the ICN from the offer distributor 102, based on the need for the gift determined by the offer distributor 102. Next the payment processor 103 generates the ICN with the appropriate controls and sends an API response to the offer distributor 102, which in turn submits the gift with the ICN to an application. In an embodiment, this application is the Gift APP depicted in FIG. 10 and describe above with reference to FIG. 10. At this point, the gift is received within the application by the consumer 101. As shown in FIG. 10, this receipt can be accomplished via a Gift APP executing on a mobile device 601 associated with the consumer 101.

The gift management process 1110 comprises the steps and stages described below. First, the offer distributor 102 determines if there is need to cancel or modify the gift. In response to determining that the gift needs to be cancelled or dynamically modified (i.e., to change the gift amount/maximum, usage controls, recipient(s), or other dynamic modifications after the gift has been created), the offer distributor 102 makes an API call to the payment processor 103, which in turn invalidates the ICN or modifies controls for the gift.

The dynamic gift card redemption process 1020 comprises the steps and stages described below. First, the consumer 101 presents the gift at a merchant 104 where the consumer 101 wishes to redeem the gift, which in turn initiates authorization at the merchant's 104 POS (i.e., at a POS terminal). Next, in an optional embodiment, a transaction acquirer 504 identifies a payment processor 103 (i.e., MasterCard) for the transaction and routes it accordingly. At this point, payment processor 103 can use an authorization system (MasterCard's inControl™ in the exemplary embodiment of FIG. 11) to validate and map the RCN before control is passed to the issuer 550, which then either authorizes or declines the transaction at the RCN level. As noted in item 1 in FIG. 11 the flow for declining a gift is similar to the approval flow, except that a decline message is sent back to the merchant 104 instead of an authorization message. Next, in response to receiving an authorization message, the payment processor 103 registers the authorized transaction and passes the authorization for the gift value to the merchant 104. As shown in FIG. 11, in an optional step, the merchant 104 can initiate a transaction for clearance and settlement as part of a business as usual (‘BAU’) transaction. As indicated by the dashed lines in FIG. 11, these clear and settle transactions can trigger steps of the dynamic gift funding process 1130 and gift metric collection process 1140 described below. The merchant 104 then calculates any overage spent by the consumer 101 at the merchant 104. Exemplary systems and methods for managing and processing such overages are described in U.S. Provisional Appl. No. 61/586,049, entitled “Systems and Methods for Managing Overages in Daily Deals,” filed Jan. 12, 2012, which is incorporated by reference herein in its entirety. After the overage is calculated, the consumer 101 pays for any additional overage and then receives the good/service associated with the gift from the merchant 104.

The dynamic gift funding process 1130 comprises the steps and stages described below. First, the offer distributor 102 (i.e., the deal company) bills the merchant 104 for any redeemed gift(s). In response, the merchant 104 remits funding for gifts redeemed and then passes control back to the offer distributor 102, which in turn pays the RCN bill to the issuer 550. It is to be understood that a consumer 101 could also provide or give a gift to another consumer 101 (i.e., a friend, colleague, family member, client, etc. who is the recipient of the gift). In this embodiment, the giving consumer 101 would pay for the gift and provide an ICN to the recipient to be used at a particular merchant 104.

The gift metric collection process 1140 comprises the steps and stages described below. First, the offer distributor 102 initiates an ICN status inquiry and then makes an API call to update a data store at the payment processor 103. In the example illustrated in FIG. 11, this data store is a MasterCard inControl™ database. Next the payment processor 103 sends an API response with the ICN stats to the offer distributor 102. As indicated by item 2 in FIG. 11, in embodiments, the basic ICN status received by the payment processor 103 in this step can include, but are not limited to, Allocated, Approved, and Declined.

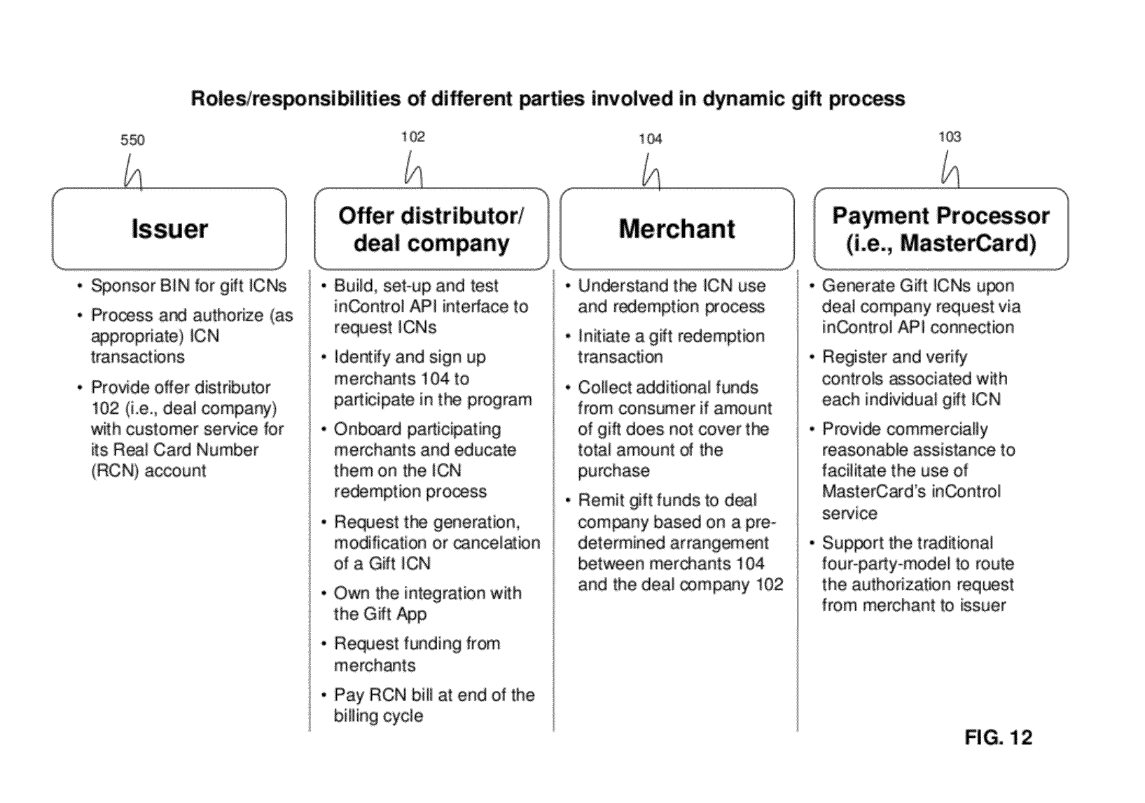

FIG. 12 illustrates roles and responsibilities of entities involved in dynamic gift processing. In particular, FIG. 12 delineates exemplary roles and responsibilities of the entities and parties involved in dynamic gift processes and methods described above with reference to FIGS. 10 and 11. FIG. 12 is described with continued reference to the embodiments illustrated in FIGS. 1, 2, 5, 10, and 11. However, FIG. 12 is not limited to those embodiments. It is to be understood that not all of the parties and corresponding roles/responsibilities are required to carry out the various dynamic gift processes and steps described above with reference to FIGS. 10 and 11.

As indicated in FIG. 12, an issuer 550 can have one or more of the following responsibilities as a player in dynamic gift processing: sponsor a BIN for gift ICNs; processing and authorizing (as appropriate) ICN transactions; and providing an offer distributor 102 (i.e., deal company) with customer service for its Real Card Number (RCN) account.

As shown in FIG. 12, in embodiments, the offer distributor 102 (i.e., the deal company) can serve one or more of the following roles as an entity involved in the dynamic gift process: building, setting-up and testing an inControl™ API interface to request ICNs; identifying and signing up merchants 104 to participate in the gift program; onboarding participating merchants 104 and educating them on the ICN redemption process; requesting generation, modification or cancellation of a gift ICN; owning integration with the Gift APP; requesting funding from merchants 104; and paying the RCN bill at end of the billing cycle.

With continued reference to FIG. 12, a merchant 104 can fulfill one or more of the following roles as part of dynamic gift processing: understanding ICN use and the gift redemption process 1020; initiating a gift redemption transaction; collecting additional funds from a consumer 101 if an amount of a gift (i.e., due to controls) does not cover a total amount of a purchase at a merchant 104; and remitting gift funds to the deal company 102 based on a pre-determined arrangement between merchants 104 and the deal company 102.

Lastly, FIG. 12 indicates that a payment processor 103, such as, but not limited to, MasterCard can have one or more of the following responsibilities for completing dynamic gift processing: generating gift ICNs in response to a deal company 102 request via an authorization system API connection (e.g., an API connection to MasterCard's inControl™ service); registering and verifying controls associated with each individual gift ICN; providing commercially reasonable assistance to facilitate the use of an authorization system, such as MasterCard's inControl™ service; and supporting a traditional four-party-model (i.e., comprising communications between a merchant 104, a transaction acquirer 504, an issuer 550, and a consumer 101) to route an authorization request from a merchant 104 to an issuer 550.

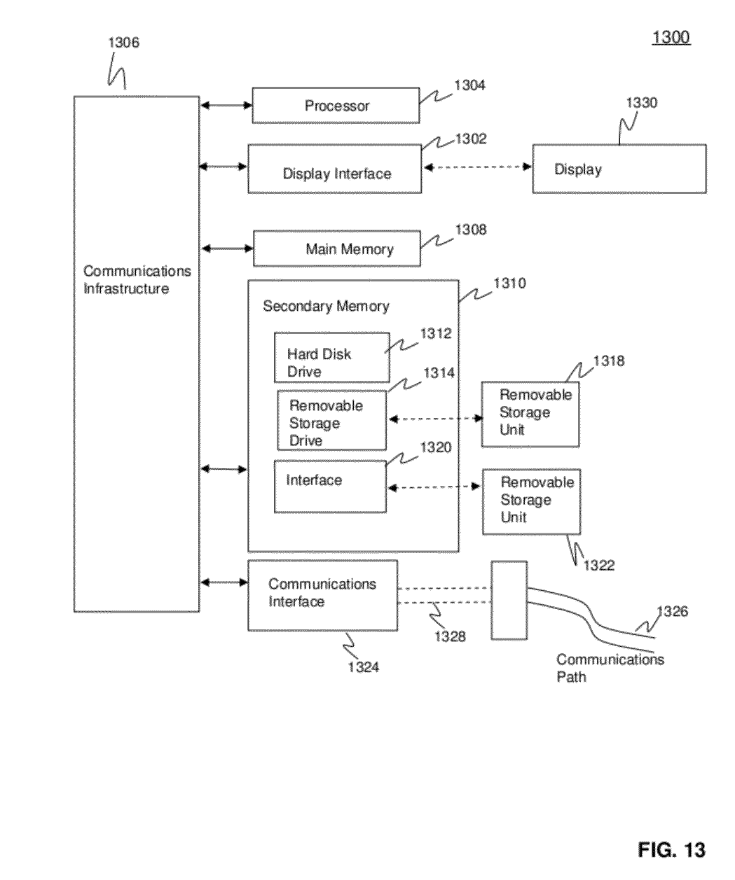

It will be appreciated that one or more exemplary embodiments of the present invention can provide one or more advantages or none at all. For example, improved merchant and acquirer control over offer verification, redemption and authorization of the underlying financial transaction can be provided by leveraging conventional authorization processes. Techniques of one or more embodiments of the present system can allow verifying that the offer is able to be used for a given purchase at a given time, including steps such as determining if the offer or gift is valid. The system can employ hardware and/or software aspects. As described below with reference to FIG. 13, software can include, but is not limited to, firmware, resident software, microcode, etc., that has been compiled to program a general purpose computer to be a specific purpose computer, or run a specific purpose computer.

### IV. EXAMPLE COMPUTER SYSTEM IMPLEMENTATION

As described below with reference to FIG. 13, software might be employed, for example, in connection with one or more of terminals of the consumer 101, the offer distributor 102, and the payment processing network 103, the offer sponsor/merchant 104 or the financial administrator 105. Firmware might be employed, for example, in connection with payment devices such as cards or POS terminals. Different method steps can be performed by different processors. The database 103B memory could be distributed or local and the processors could be distributed or singular. The memory devices could be implemented as an electrical, magnetic or optical memory, or any combination of these or other types of storage devices (including memory portions as described above with respect to cards. It should be noted that if distributed processors are employed, each distributed processor that makes up a processor carrying out a function or step generally contains its own addressable memory space. It should also be noted that some or all of computer systems can be incorporated into an application-specific or general-use integrated circuit. For example, one or more method steps could be implemented in hardware in an ASIC rather than using firmware. Displays used in conjunction with each of the entities and processors are representative of a variety of possible input/output devices.

As would be appreciated by someone skilled in the relevant art(s) and described below with reference to FIG. 13, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on elements 101 (i.e., a computing device associated with consumer 101), 601, 102, 103, 104, 105, 503, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

By way of example, a terminal apparatus associated with each of 101 through 105 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). By way of yet a further example, an active file manager apparatus for processing an active file in a payment system, could include a memory, and at least one processor coupled to the memory. The processor can be operative to perform one or more method steps described herein, or otherwise facilitate their performance.

Aspects of the present disclosure shown in FIGS. 1, 2 3A, 3B and 4-12, or any part(s) or function(s) thereof, may be implemented using hardware, software modules, firmware, tangible computer readable media having instructions stored thereon, or a combination thereof and may be implemented in one or more computer systems or other processing systems.

FIG. 13 illustrates an example computer system 1300 in which embodiments of the present disclosure, or portions thereof, may be implemented as computer-readable code. For example, architecture 100 and system 500 of FIGS. 1, 2 and 5, can be implemented in computer system 1300 using hardware, software, firmware, non-transitory computer readable media having instructions stored thereon, or a combination thereof and may be implemented in one or more computer systems or other processing systems. Hardware, software, or any combination of such may embody any of the modules and components used to implement the architectures and systems of FIGS. 1, 2 and 5. Similarly, hardware, software, or any combination of such may embody modules and components used to implement the processes and methods of FIGS. 3A, 3B, 4 and 6-12.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 1300. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1304 may be a special purpose or a general purpose processor device. As will be appreciated by persons skilled in the relevant art, processor device 1304 may also be a single processor in a multi-core/multiprocessor system, such system operating alone, or in a cluster of computing devices operating in a cluster or server farm. Processor device 1304 is connected to a communication infrastructure 1306, for example, a bus, message queue, network, or multi-core message-passing scheme.

Computer system 1300 also includes a main memory 1308, for example, random access memory (RAM), and may also include a secondary memory 1310. Secondary memory 1310 may include, for example, a hard disk drive 1312, removable storage drive 1314. Removable storage drive 1314 may comprise a floppy disk drive, a magnetic tape drive, an optical disk drive, a flash memory, or the like.

The removable storage drive 1314 reads from and/or writes to a removable storage unit 1318 in a well-known manner. Removable storage unit 1318 may comprise a floppy disk, magnetic tape, optical disk, etc. which is read by and written to by removable storage drive 1314. As will be appreciated by persons skilled in the relevant art, removable storage unit 1318 includes a non-transitory computer usable storage medium having stored therein computer software and/or data.

In alternative implementations, secondary memory 1310 may include other similar means for allowing computer programs or other instructions to be loaded into computer system 1300. Such means may include, for example, a removable storage unit 1322 and an interface 1320. Examples of such means may include a program cartridge and cartridge interface (such as that found in video game devices), a removable memory chip (such as an EPROM, or PROM) and associated socket, and other removable storage units 1322 and interfaces 1320 which allow software and data to be transferred from the removable storage unit 1322 to computer system 1300.

Computer system 1300 may also include a communications interface 1324. Communications interface 1324 allows software and data to be transferred between computer system 1300 and external devices. Communications interface 1324 may include a modem, a network interface (such as an Ethernet card), a communications port, a PCMCIA slot and card, or the like. Software and data transferred via communications interface 1324 may be in the form of signals, which may be electronic, electromagnetic, optical, or other signals capable of being received by communications interface 1324. These signals may be provided to communications interface 1324 via a communications path 1326. Communications path 1326 carries signals and may be implemented using wire or cable, fiber optics, a phone line, a cellular phone link, an RF link or other communications channels.

In this document, the terms “computer program medium,” “non-transitory computer readable medium,” and “computer usable medium” are used to generally refer to tangible media such as removable storage unit 1318, removable storage unit 1322, and a hard disk installed in hard disk drive 1312. Signals carried over communications path 1326 can also embody the logic described herein. Computer program medium and computer usable medium can also refer to memories, such as main memory 1308 and secondary memory 1310, which can be memory semiconductors (e.g. DRAMs, etc.). These computer program products are means for providing software to computer system 1300.

Computer programs (also called computer control logic) are stored in main memory 1308 and/or secondary memory 1310. Computer programs may also be received via communications interface 1324. Such computer programs, when executed, enable computer system 1300 to implement the present disclosure as discussed herein. In particular, the computer programs, when executed, enable processor device 1304 to implement the processes of the present disclosure, such as the steps and stages in the methods illustrated by FIGS. 3A, 3B, 4 and 6-12, discussed above. Accordingly, such computer programs represent controllers of the computer system 1300. Where the present disclosure is implemented using software, the software may be stored in a computer program product and loaded into computer system 1300 using removable storage drive 1314, interface 1320, and hard disk drive 1312, or communications interface 1324.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

### V. CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of providing offers to consumers, the method comprising:
providing an offer to at least one consumer;
receiving an indication of acceptance of the offer by the at least one consumer;
initiating processing of a payment from a particular consumer using a financial transaction card number associated with the particular consumer; and
sending an intelligent transaction card (ITC) number to the particular consumer so that the ITC number can be used as a redemption code to purchase products or services contained in said offer.

2. The method of claim 1, wherein the processing comprises mapping the particular consumer's financial transaction card number to an ITC that is associated in a database to parameters of the offer.

3. The method of claim 1, wherein the ITC number also acts as the redemption code.

4. The method of claim 1, further comprising receiving an indication of completion of acceptance of the offer by the particular consumer with a merchant.

5. A method of verifying and redeeming an offer, the method comprising:
receiving a request for an intelligent transaction card (ITC) number that is associated with parameters of an offer targeted for at least one consumer;
receiving financial transaction card information for the at least one consumer and associating said financial transaction card information with an ITC number associated with parameters of an offer accepted by the at least one consumer;
receiving a request for authorization of a transaction based on said ITC number;
checking transaction details against parameters of the accepted offer; and
in response to determining, based at least in part on the checking, that the transaction details are within the parameters of the accepted offer, approving the transaction for further processing as part of a transaction authorization process, wherein the further processing comprises automatically settling any money owed to a merchant where the accepted offer is redeemed.

6. The method according to claim 5, further comprising, in response to determining, based at least in part on the checking, that the transaction details are outside the parameters of the accepted offer, denying the transaction.

7. The method according to claim 5, further comprising reporting transaction details with or without personally identifiable information at least one of consumers, merchants, offer distributors, and advertisers.

8. A non-transitory computer readable storage medium having program instructions stored thereon for generating and redeeming a limited-use dynamic gift, the instructions being executable by a processor of a computing device, the instructions comprising:
instructions for requesting a limited gift code based on desired controls for a limited-use, dynamic gift,
instructions for forwarding an indication of the gift and the gift code to a gift application accessible by a consumer;
in response to receiving an indication that the consumer has initiated redemption of the gift for goods or services from a merchant, instructions for receiving the gift code and an authorization from the merchant;
instructions for checking the validity of the gift against the controls based on the initiated redemption;
instructions for approving the gift redemption for further processing as part of a transaction authorization process in response to determining, based on the checking, that the initiated redemption is within the controls; and
instructions for denying the gift redemption in response to determining, based on the checking, that the initiated redemption is outside the controls.

9. The non-transitory computer readable storage medium of claim 8, wherein the limited gift code is a 16-digit intelligent coupon number (ICN) and wherein the instructions for receiving comprise instructions for receiving the 16-digit ICN from a card reader or point-of-sale (POS) terminal associated with the merchant.

10. The non-transitory computer readable storage medium of claim 8, wherein the authorization received from the merchant is for a full amount of the gift to a funding account managed by a payment processor.

11. The non-transitory computer readable storage medium of claim 8, wherein the gift can be requested by one or more of a merchant, a deal publisher, or a consumer who wishes to give the gift to another consumer, and wherein the controls can be dynamically altered by the requestor after the indication of the gift and the gift code has been forwarded to the gift application.

12. The non-transitory computer readable storage medium of claim 8, wherein the controls include one or more of:
monetary value controls based on a total amount of a purchase at a merchant;
constraints on redeeming the gift at specific merchant locations;
constraints on redeeming the gift in specific geographic locations or regions;
constraints on using the gift at specific categories of merchants; and
time of usage constraints.

13. The non-transitory computer readable storage medium of claim 12, wherein the time of usage constraints include one or more of:
time of day constraints;
day of week constraints;
specific date constraints; and
an expiration date.

14. The non-transitory computer readable storage medium of claim 12, wherein the constraints on using the gift at specific categories of merchants are based on merchant category codes (MCCs) associated with or assigned to specific merchants.

15. The non-transitory computer readable storage medium of claim 8, wherein the instructions for forwarding comprise instructions for forwarding an indication of the gift and the gift code to the consumer as one or more of:
an electronic or physical voucher;
a physical gift card;
an email message addressed to an email address associated with the consumer; and
a Short Message Service (SMS) text message addressed to a phone number associated with the consumer.

16. The non-transitory computer readable storage medium of claim 8, wherein instructions for forwarding comprise instructions for forwarding the indication of the gift and the gift code to a gift application installed on a computing device associated with the consumer, and wherein the consumer is an intended recipient of the gift.

17. The non-transitory computer readable storage medium of claim 16, wherein the computing device is a mobile device associated with the consumer and the gift application is a gift APP installed on the mobile device.

18. A system for generating and redeeming a limited-use dynamic gift, the system comprising:
means for receiving an indication of a redemption, by a consumer, of the gift, the gift having been purchased with an account previously-enrolled in the system;
means for receiving an intelligent transaction card (ITC) number used with a gift code to purchase products or services from a merchant, wherein the ITC number indicates a total amount of a transaction at the merchant, and wherein the total amount includes an amount of the gift and an overage spent by the consumer at the merchant in addition to the amount of the gift;
means for using the received ITC number and gift code to validate the gift;
means for calculating an overage for the redemption at the merchant;
means for requesting an additional form of payment for the overage in response to determining that the previously-enrolled account is not authorized to be used to pay for the overage; and
means for processing the amount of the gift and the calculated overage within a payment processing network.

19. The system of claim 18, further comprising means for processing, in the payment processing network, a transaction for a nominal amount to enable subsequent authorization and processing of the overage.

20. An apparatus configured to verify and redeem an offer, the apparatus comprising:
means for receiving a request for an intelligent transaction card (ITC) number that is associated with parameters of an offer communicated to at least one consumer;
means for receiving a consumer's financial transaction card information;
means for associating the received financial transaction card details with an ITC number associated with parameters of an offer accepted by a consumer;
means for receiving a request of authorization of a transaction based on said ITC number; and
means for checking transaction details against controls associated with the accepted offer, and if within those controls, approving the transaction for further processing as part of a transaction authorization process, and if not within those controls, causing the transaction to be denied.
